(19) United States
(12) Patent Application Publication
(10) Pub. No.: US 2017/0228138 A1
(43) Pub. Date: Aug. 10, 2017

(54) SYSTEM AND METHOD FOR SPATIAL INTERACTION FOR VIEWING AND MANIPULATING OFF-SCREEN CONTENT

(71) Applicant: University of Ontario Institute of Technology, Oshawa (CA)

(72) Inventors: Erik Paluka, Aurora (CA); Christopher COLLINS, Toronto (CA)

(21) Appl. No.: 15/427,631

(22) Filed: Feb. 8, 2017

Related U.S. Application Data
(60) Provisional application No. 62/292,667, filed on Feb. 8, 2016.

(51) Int. Cl. G06F 3/0484; G06F 3/0485; G06F 3/01

(52) U.S. Cl. CPC G06F 3/04845; G06F 3/017; G06F 3/0485; G06F 3/04842

(57) ABSTRACT

When an information space is larger than the display, it is typical for interfaces to only support interacting with content that is rendered within its viewport. Various embodiments are described herein for several spatial off-screen exploration techniques that make use of the interaction space around the physical display to support interacting with off-screen content. These techniques include one or more of Paper Distortion, Dynamic Distortion, Content-Aware Dynamic Peephole Inset, Spatial Panning, and Point2Pan. To enable a detailed analysis of spatial interaction systems, a web-based visualization system was developed called SpatialVis, which visualizes logged data of a video screen capture of the associated user interface for various spatial interactions by the user.

### CROSS-REFERENCE TO RELATED APPLICATION

This application claims the benefit of U.S. Provisional Patent Application No. 62/292,667 filed Feb. 8, 2016; the entire contents of Patent Application No. 62/292,667 are hereby incorporated by reference.

### FIELD

Various embodiments are described herein for systems and methods for allowing a user to spatially interact with off-screen content.

### BACKGROUND

Since the beginning of the personal computer revolution, interacting with digital content has, for the most part, revolved around physically manipulating indirect input devices (e.g. pointing devices, and analog sticks). The problem with this type of human-computer interaction is that it is not natural when compared to how humans interact in the physical world. In large part, humans tend to not use an external device to grasp an object; rather, humans use their hands to directly perform the action. If humans can leverage these interaction skills that they have honed since childbirth instead of creating and using new unfamiliar ones, the communication between man and machine will become more intuitive and natural, and have a lower learning curve. Direct touch technology and tangible user interface objects have helped to bridge this gap. However, indirect input devices that require physical contact are still ubiquitous in the computing world.

When using gesture-based spatial interaction, there are generally two types of input: movement of objects and/or organisms, and the state of those objects and/or organisms (i.e. movement equals position+velocity information and state equals orientation+arrangement of fingers, etc.). The difference between this type of interaction and standard interfaces is in the myriad of states, movements and positions that these objects, organisms or parts thereof can be in. Also, most desktop user interface designs in today's age are based on the WIMP paradigm (windows, icons, menus, pointers) and rely on the accuracy of pointing devices to allow their GUI elements to have small input spaces. Usability issues occur when spatial interaction techniques are used to interact with these interfaces. Since the human body is constantly moving when not supported by an object or surface, the cursor tends to move in and out of the GUI elements' small input spaces when using a finger, hand or arm as input.

### SUMMARY OF VARIOUS EMBODIMENTS

In a broad aspect, at least one embodiment described herein provides a system that provides spatial interaction with off-screen content, wherein the system comprises a display for displaying initial on-screen content; a motion sensor unit for detecting gestures made by a user for selecting desired off-screen content and generating spatial interaction data; and a processing unit coupled to the display and the motion sensor unit, the processing unit being configured to define an information space that comprises on-screen content and off-screen content that extends physically past one or more boundaries of the display and a spatial interaction mode, and upon receiving spatial interaction data from the motion sensor unit of a user gesture that corresponds to the spatial interaction mode, the processing unit is configured to apply a geometric transformation to the information space so that the on-screen content that is displayed by the display is modified to include the selected off-screen content.

In at least some embodiments, the processing unit may be configured to inverse the applied geometric transformation after the motion sensor unit detects that the user's gesture is completed.

In at least some embodiments, the processing unit may be configured not to inverse the applied geometric transformation after the motion sensor unit detects that the user's gesture is completed when the processing unit detects that the user has also locked the information space.

In at least some embodiments, the processing unit may be configured to inverse the applied geometric transformation when the processing unit detects that the user unlocks the view.

In at least some embodiments, the physical space surrounding the display is generally divided into off-screen interaction volumes that may comprise at least one of an upper left corner volume, an above volume, an upper right corner volume, a right volume, a lower right corner volume, a below volume, a lower left corner volume, a left volume, an in front volume, and a behind volume.

In at least some embodiments, the spatial interaction modes may comprise at least one of paper distortion, dynamic distortion, content-aware distortion, point2pan, spatial panning and dynamic peephole inset.

In at least some embodiments, in the paper distortion and dynamic distortion modes, the processing unit may retain the initial on-screen content, compress/warp and display the initial on-screen content and display selected off-screen content by translating the off-screen content onto the display.

In at least some embodiments, in the paper distortion mode, when the processing unit detects that the user makes at least one contact with the display, the display may record the at least one contact as tactile spatial interaction data which may be used to determine a portion of the initial on-screen content that is compressed.

In at least some embodiments, in the dynamic distortion mode, the motion sensor unit may be constantly monitoring movement in the user's gesture and the movement is used to dynamically change the amount of compression that is applied to the initial screen content.

In at least some embodiments, in the point2pan mode, the processing unit detects that the user gesture comprises the user pointing towards the desired off-screen content, and the processing unit may translate the information space to display the desired off-screen content.

In at least some embodiments, in the point2pan mode, the processing unit may translate the information space so that the desired off-screen content is centered on the display.

In at least some embodiments, in the content-aware distortion mode, the processing unit may apply a geometric transformation to regions of pixels of the initial on-screen content based on an information content in the regions of pixels.

In at least some embodiments, in the dynamic peephole inset mode, the processing unit may use the position of the user's hand in the off-screen information space to define content that is placed in an inset/viewport that is shown on the display.

In at least some embodiments, an overview and detail visualization with an additional viewfinder that represents a location of the selected off-screen content may be shown.

In another broad aspect, at least one embodiment described herein provides a method of allowing a user to spatially interact with off-screen content of a device, wherein the method comprises: defining an information space that comprises on-screen content and off-screen content that extends physically past one or more boundaries of the display and a spatial interaction mode; displaying initial on-screen content on a display; detecting a gesture made by a user for selecting desired off-screen content using a motion sensor unit and generating spatial interaction data; upon receiving the spatial interaction data from the motion sensor unit of a user gesture that corresponds to the spatial interaction mode, applying a geometric transformation to the information space so that on-screen content that is displayed by the display is modified to include the selected off-screen content.

In at least some embodiments, the method may comprise inversing the applied geometric transformation after the motion sensor unit detects that the user's gesture is completed.

In at least some embodiments, the method may comprise not inversing the applied geometric transformation after the motion sensor unit detects that the user's gesture is completed when the processing unit detects that the user has also locked the information space.

In at least some embodiments, the method may comprise inversing the applied geometric transformation when the processing unit detects that the user unlocks the view.

In at least some embodiments, the physical space surrounding the display may be divided into off-screen interaction volumes comprising at least one of an upper left corner volume, an above volume, an upper right corner volume, a right volume, a lower right corner volume, a below volume, a lower left corner volume, a left volume, an in front volume, and a behind volume.

In at least some embodiments, the spatial interaction modes may comprise at least one of paper distortion, dynamic distortion, content-aware distortion, point2pan, spatial panning and dynamic peephole inset.

In at least some embodiments, in the paper distortion and dynamic distortion modes, the method may comprise retaining the initial on-screen content, compressing/warping and displaying the initial on-screen content and displaying selected off-screen content by translating the selected off-screen content onto the display.

In at least some embodiments, in the paper distortion mode, when the processing unit detects that the user makes at least one contact with the display, the method may comprise recording the at least one contact as tactile spatial interaction data, and using the tactile spatial interaction data to determine a portion of the initial on-screen content that is compressed.

In at least some embodiments, in the dynamic distortion mode, the method may comprise constantly monitoring movement in the user's gesture and using the movement to dynamically change the amount of compression that is applied to the Initial screen content.

In at least some embodiments, in the point2pan mode, the processing unit detects that the user gesture may comprise the user pointing towards the desired off-screen content, and the method may comprise translating the information space to display the desired off-screen content.

In at least some embodiments, in the point2pan mode, the method may comprise translating the information space so that the desired off-screen content is centered on the display.

In at least some embodiments, in the content-aware distortion mode, the method may comprise applying geometric transformation to regions of pixels of the initial on-screen content based on an information content of the regions of pixels.

In at least some embodiments, in the dynamic peephole inset mode, the processing unit may use the position of the user's hand in the off-screen information space to define content that is placed in an inset/viewport that is shown on the display.

In at least some embodiments, the method may comprise showing an overview and detail visualization with an additional viewfinder that represents a location of the selected off-screen content.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now briefly described. The drawings are not intended to limit the scope of the teachings described herein.

FIG. 1A shows an example embodiment of a system for enabling spatial interaction by users for viewing and manipulating off-screen content.

FIG. 1B shows an example of the information space with respect to the display of the system of FIG. 1A.

FIG. 1C shows an example embodiment of the spatial interaction unit in relation to the display and information space of FIG. 1B.

FIG. 2A shows an example setup for the spatial interaction unit, display, keyboard and mouse of the system of FIG. 1A.

FIG. 2B shows a Field Of View (FOV) for a motion detector used in the spatial interaction unit of FIG. 1A.

FIG. 2C shows a Cartesian coordinate system for the motion detector of FIG. 2A.

FIG. 3 shows an example embodiment of interaction spaces for the display of the system of FIG. 1A, according to a descriptive framework defined herein, when operating under a dynamic distortion spatial off-screen interaction mode.

FIG. 4A shows a flowchart of an example embodiment of a method for enabling a user to spatially interact with an off-screen portion of an information space.

FIG. 4B shows a flowchart of an example embodiment of a method for enabling a paper distortion spatial interaction technique in accordance with the teachings herein.

FIG. 4C shows a flowchart of an example embodiment of a method for enabling a dynamic distortion spatial interaction technique in accordance with the teachings herein.

FIG. 4D shows a flowchart of an example embodiment of a method for enabling a point2pan spatial interaction technique in accordance with the teachings herein.

FIG. 5A shows an example of a dynamic distortion of the information space due to a user hand gesture external to a side of the display.

FIG. 5B shows an example of a dynamic distortion of the information space due to a user hand gesture external to a lower corner of the display.

FIG. 5C shows an example of a dynamic distortion of the information space due to a user hand gesture above a top of the display.

FIG. 5D shows an example of a dynamic distortion of the information space due to a user hand gesture external to a side of the display in which the distortion is along low energy seams of the information space.

FIG. 6A shows an example of a paper distortion of the information space when one user finger touches the display and the user's other hand gestures external to a side of the display.

FIG. 6B shows an example of a paper distortion of the information space when two user fingers touch the display and the user's hand gestures external to a side of the display.

FIG. 6C shows an example of a paper distortion of the information space without any user fingers touching the display and the user's hand gesturing external to a side of the display.

FIG. 7 shows an example of a dynamic peephole distortion of the information space with a user hand gesture external to a side of the display.

FIG. 8A shows an example of a point to pan distortion of the information space when a user's finger gestures in front of the display.

FIG. 8B shows an example of how an object becomes highlighted when the cursor hovers over it to facilitate the user performing a mid-air tap selection gesture.

FIG. 9A shows an example of a document exploration mode where a portion of the off-screen information space can be used as interaction areas to invoke system-wide or application specific commands.

FIG. 9B shows an example of how the document exploration mode allows a user to simultaneously view content that appears on two distant pages.

FIG. 10A shows an example embodiment of how spatialVis can be used for visualizing logged spatial interaction data.

FIG. 10B shows an example of how SpatialVis can be used in analysis to (a) visualize a portion of the spatial interaction data; (b) perform brushing to show data only associated for 8 to 12 seconds into the video; (c) save the visualization state; (d) add annotations to the spatial interaction data; (e) generate a heatmap of data associated with 8 to 12 seconds into the video and (f) generate a video timeline of the spatial interaction data.

FIG. 11A shows a picture of a map that was used in a study, and has been overlaid with rectangular boxes to depict certain regions used for testing in the study.

FIG. 11B shows an example of an experimental process that was used in a study of spatial interaction techniques.

FIG. 11C shows experimental results of participant mean task completion time in milliseconds for a search task using different interaction techniques.

FIG. 11D shows experimental results of participant mean task completion time in milliseconds for a select-only task using the different interaction techniques.

FIG. 12A shows experimental results of participant mean task completion time in milliseconds for a search task when using different interaction techniques in relation to close and far radial distance ranges.

FIG. 12B shows experimental results of participant mean task completion time in milliseconds for a select-only task when using different interaction techniques in relation to close and far radial distance ranges.

FIG. 13A shows experimental results of participant mean task completion time in milliseconds for a search task in the close and far radial distance ranges.

FIG. 13B shows experimental results of participant mean task completion time in milliseconds for a select-only task in the close and far radial distance ranges.

FIG. 14A shows experimental results of participant mean accuracy levels in percentages for a search task when using different interaction techniques.

FIG. 14B shows experimental results of participant mean accuracy levels in percentages for a search task when using different interaction techniques in relation to the close and far radial distance ranges.

FIG. 14C shows experimental results of participant mean accuracy levels in percentages for a search task in the close and far radial distance ranges.

FIG. 15 shows the study participants' answers to the 7-point Likert scale questions in a post-study questionnaire.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to systems or methods having all of the features of any system or method described below or to features common to several or all of the systems and methods described herein. It is possible that there may be a system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term such as 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount, such as 1%, 2%, 5%, or 10%, for example, of the number to which reference is being made if the end result is not significantly changed.

The example embodiments of the systems or methods described in accordance with the teachings herein may be implemented as a combination of hardware and software. For example, the embodiments described herein may be implemented, at least in part, by using one or more computer programs, executing on one or more programmable devices comprising at least one processing element, and at least one data storage element (including volatile and non-volatile memory and/or storage elements). These devices have input devices including a spatial motion unit, possibly a touch screen and possibly a keyboard, a mouse, and the like, as well as a display screen and possibly other output devices such as a printer, and the like depending on the nature of the device.

It should also be noted that there may be some elements that are used to implement at least part of the embodiments described herein that may be implemented via software that is written in a high-level procedural language such as object oriented programming. The program code may be written in C, C++ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or Interpreted language.

At least some of these software programs may be stored on a storage media (e.g. a computer readable medium such as, but not limited to, ROM, magnetic disk, optical disc) or a computing device that is readable by a general or special purpose programmable device having a processor, an operating system and the associated hardware and software that is necessary to implement the functionality of at least one of the embodiments described herein. The software program code, when read by the computing device, configures the computing device to operate in a new, specific and predefined manner in order to perform at least one of the methods described herein.

It should be noted that the use of the terms such as information space, off-screen information space and on-screen information space not only refers to information content but also to the corresponding image data that encodes the information content. Furthermore, when the information space is transformed by a geometric transformation such as one or more of translation, compression, expansion, bubble magnification (i.e. fisheye) and the like, the transformations are applied to the underlying image data to determine the display data that is shown as pixels on a display of a computing device.

Furthermore, at least some of the programs associated with the systems and methods of the embodiments described herein may be capable of being distributed in a computer program product comprising a computer readable medium that bears computer usable instructions, such as program code, for one or more processors. The medium may be provided in various forms, including non-transitory forms such as, but not limited to, one or more diskettes, compact disks, tapes, chips, and magnetic and electronic storage devices. In alternative embodiments, the medium may be transitory In nature such as, but not limited to, wire-line transmissions, satellite transmissions, Internet transmissions (e.g. downloads), media, digital and analog signals, and the like. The computer useable instructions may also be in various formats, including compiled and non-compiled code.

Display screens tend to be smaller than a person's field of vision with respect to desktop or laptop computers and especially with respect to mobile devices. Therefore, when an information space is larger than the display (i.e. viewport or screen), it is typical for interfaces to only support interacting with content from the information space that is rendered within its display. This limits user interaction with the information space. To always allow content (e.g., widgets) to be interacted with, popular operating systems and applications constrain the information space to the size of the screen. Albeit, this causes the display space on many systems to suffer from what is called the graphical clutter problem. Furthermore, in standard GUIs, the screen is often cluttered with elements that are not always needed for the user's current task (e.g., taskbar, icons, ribbons, etc.). These elements may potentially be distracting, as well as reducing the space allocated for the content and tools needed for the task. Standard solutions include minimizing visual elements, such as windows, to a designated storage space on the screen. However, this does not take advantage of human capabilities to work efficiently with custom layouts of information spaces.

In accordance with the teachings herein, the information space is no longer bounded to the size of the display such that digital content can be moved off-screen in the same plane as the display (i.e. XY plane for example) as if the display is larger than it actually is. Spatial interaction is used to interact with content in the off-screen space (i.e. at or past the periphery edges of the screen). Accordingly, with the spatial interaction techniques described herein, it is as if the movement of the cursor (e.g. pointer) is no longer limited by the physical boundaries of the display, thereby essentially extending the interactable information space.

In at least some embodiments in accordance with the teachings herein, for 2D information spaces, the information space is extended past the boundaries of the display while still supporting touch interaction. A user can then interact with and/or explore specific off-screen content by performing some type of mid-air hand gesture at the physical location that is associated with the off-screen content of interest. The spatial interaction techniques described in accordance with the teachings herein include, but are not limited to, one or more of Paper Distortion, Dynamic Distortion. Dynamic Peephole Inset, Spatial Panning, and Point2Pan methods. The spatial interaction techniques involve detecting user gestures in the off-screen information space by dividing the physical “around-screen” or “off-screen” space into interaction volumes and analyzing these interaction volumes based on different factors.

The teachings herein allow the limits of movement for digital content to be decoupled from the display space boundaries, and thus the visual clutter problem can be mitigated through the use of the surrounding off-screen areas. This allows designers to possibly create richer user experiences by using off-screen areas for other applications and use cases. For example, in at least some embodiments described herein, digital content may be placed off-screen, as well as automatically appear there, such as when an application is invoked or an email is received. In at least some embodiments, the off-screen information space may also be partitioned to create areas for different purposes, such as for user-defined storage (e.g. files, windows, directories, application specific content, and toolboxes), or notifications and incoming feed content (e.g. newsfeed, emails, chat messages).

In addition to the display periphery being used for storage and/or object placement, in at least some embodiments described herein, the off-screen information space can additionally be used as an area to perform spatially defined interactions to invoke system-wide and application-specific operations, such as changing the volume when a user vertically moves their hand at the right side of the display.

In another example, in at least some embodiments described herein, a spatial interaction mode may be defined to allow the user to perform certain software filing actions such as tossing a software file into a portion of the off-screen information space to the right side of the display to delete it, and/or tossing the file into another portion of the off-screen information space to copy it to a network storage device. This further reduces the need for on-screen widgets, as well as reduces the amount of time required for triggering operations through direct user hand manipulation without using a traditional input device.

Since the physical space around the screen may be employed to store content, according to the teachings herein, people may be able to take advantage of their spatial cognition capabilities to create custom layouts and mental maps of the virtual environment. Furthermore, by having users place their hands beside the display to interact with off-screen content (i.e. content that is in the off-screen information space) or to invoke commands, the users also benefit from their sense of proprioception reinforcing their spatial memory (e.g., spatial relationship between items). For example, when storing an object off-screen on the right side of the display, placing one's hand in the actual physical location where the object is stored reinforces one's knowledge of the object's location in the information space. The benefits of proprioception increases when users have a greater opportunity to develop an associated neural representation, such as always associating certain off-screen areas with a specific purpose within an application, operating system or other aspects of a computer system.

In accordance with the teachings herein, a user's spatial memory may also be aided by being able to use the display as a spatial reference point. When trying to retrieve the object from the last example, one may be able to reduce the size of the information space that needs to be searched due to knowledge that the item was stored on a particular off-screen side of the display. Spatial memory of an element's horizontal and vertical distance from a surface or an edge of the display (e.g., top far right corner) can be used to quickly access the item, especially since people develop an accurate memory for the locations of frequently accessed interface elements. To facilitate this, and further strengthen users' spatial memory, landmarks and other visual cues can be embedded in the interface in at least some of the embodiments described herein. Additionally, the screen of the display (e.g. monitor) makes it easier for users to spatially interact with the virtual environment since gestures are performed relative to a real-world object instead of in empty free-space.

The off-screen spatial interaction techniques described in accordance with the teachings herein may fit well with touch surfaces as the movement from touching a surface and performing mid-air gestures is more fluid compared to using a mouse or other input device. Furthermore, when these surfaces are quite large, spatial gestures may enable quick triggering of operations without requiring the user to change locations to touch the relevant element(s) such as a tool panel. On the other end, small surfaces (e.g. tablets and smartphones) may benefit the most from reduced graphical clutter and expanded virtual screen space that is possible with the teachings herein as the screen real estate is quite low for such mobile devices.

In accordance with the teachings herein, a formalized descriptive framework of the off-screen interaction space is provided that divides the around-device space into interaction volumes. Secondly, several spatial off-screen interaction techniques are described that enable a user to view and interact with off-screen content. Thirdly, in at least some embodiments, a software visual analysis tool called SpatialVis may be used for studying logged spatial interaction data and how the user interface is affected. This technique involves temporally and positionally mapping logged spatial interaction data to a video screen capture of the associated user interface.

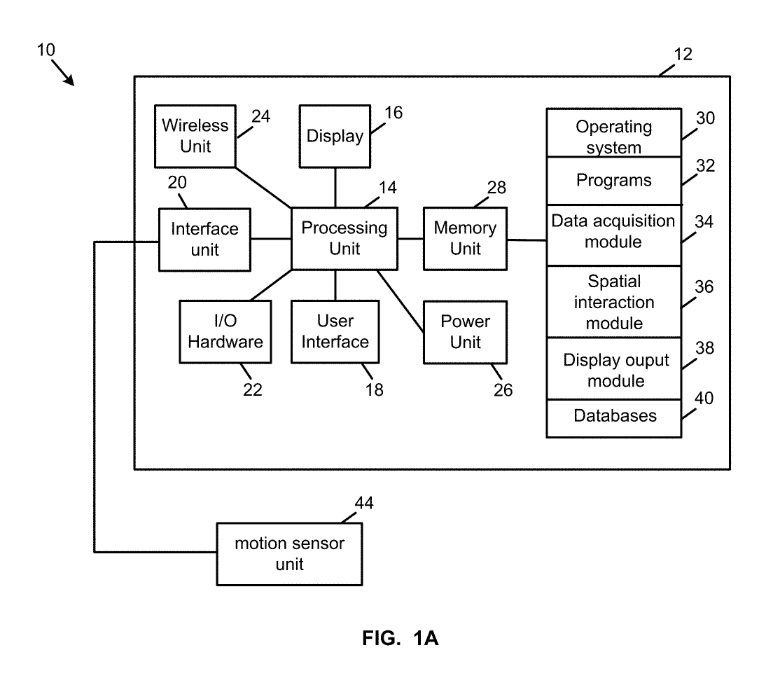

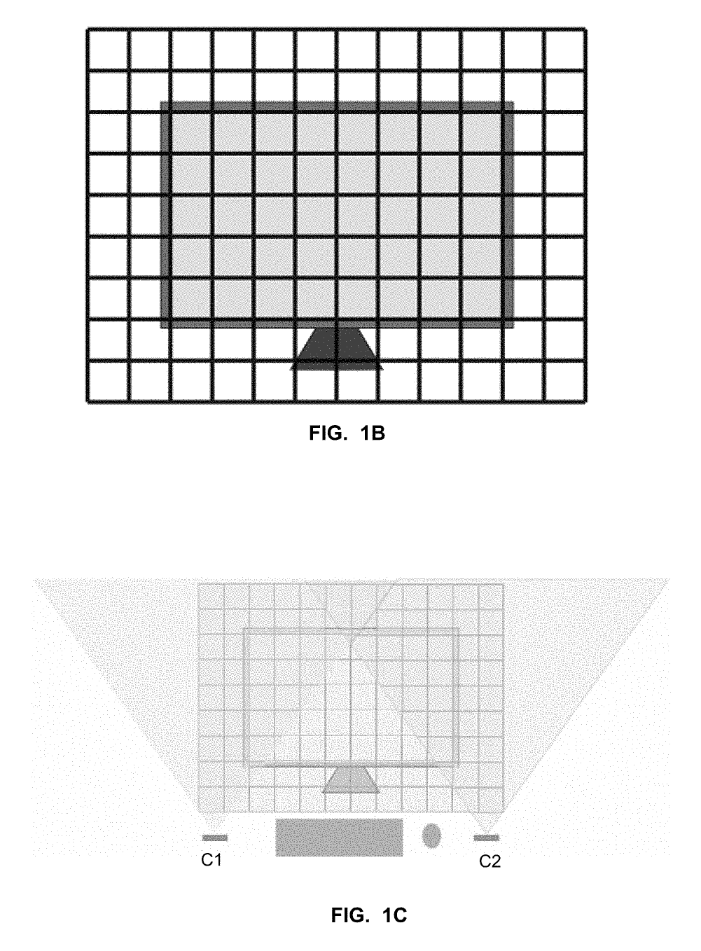

Referring now to FIG. 1A, shown therein is an example embodiment of a system 10 for enabling spatial interaction by users for viewing and manipulating off-screen content. The off-screen content are portions of the information space (i.e. portions of information data) that are not mapped to the display of the system 10 but exist in space somewhere adjacent to a portion of the display as shown in FIG. 1B where the information space is larger than the display and extends in at least one direction around the display including all directions around the display.

Referring again to FIG. 1A, the system 10 has a form factor 12 of a computing device such as, but not limited to, a mobile device, a smartphone, a smartwatch, a tablet, a laptop, a desktop computer, a wall display and an interactive table. The system 10 is provided as an example and there may be other embodiments of the system 10 with different components or a different configuration of the components described herein. The system 10 further includes several power supplies (not all shown) connected to various components of the system 10 for providing power thereto as is commonly known to those skilled in the art.

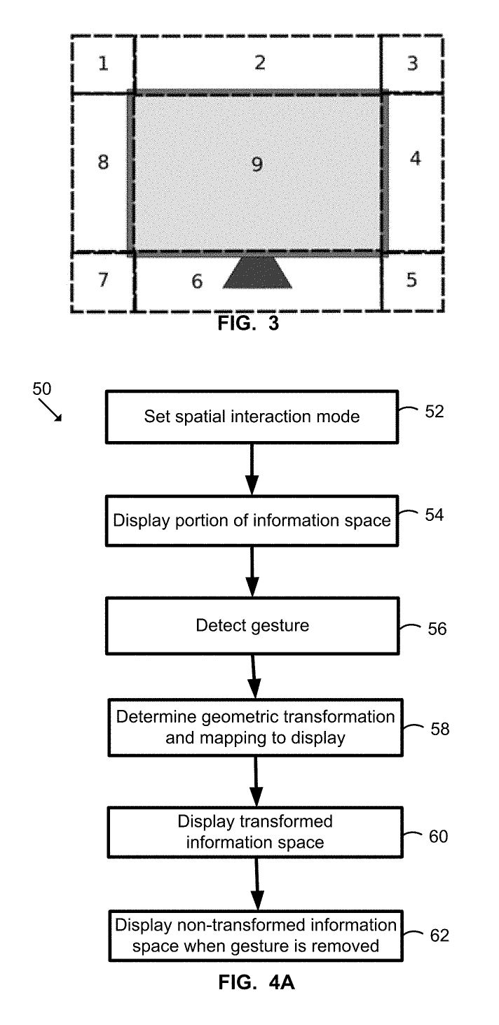

The system 10 comprises a processing unit 14, a display 16, a user interface 18, an interface unit 20, Input/Output (I/O) hardware 22, a wireless unit 24, a power unit 26, and a memory unit 28. The memory unit 28 comprises software code for implementing an operating system 30, various programs 32, a data acquisition module 34, a spatial interaction module 36, a display output module 38, and one or more databases 40. The system 10 also includes a motion sensor unit 44. Modules 34 to 38 will be described in greater detail with respect to FIGS. 3 to 9B. Some of the modules may be combined in some embodiments.

The spatial interaction techniques that may be performed using the system 10 will be described using the interaction spaces shown in FIG. 3 for gesture interaction on and around the display 16. The example interaction space shown in FIG. 3 is divided into the following volumes: an upper left (UL) corner volume 1, an above volume 2, an upper right corner (UR) volume 3, a right volume 4, a lower right corner (LR) volume 5, a below volume 6, a lower left corner (LL) volume 7, a left volume 8, and an in front volume 9. In some embodiments, there may also be an in behind volume that is opposite the in front volume and behind the display 16. Each of these volumes have advantages and disadvantages in relation to the type of computing device that is used, as well as the digital content and spatial gestures that are appropriate for each circumstance based on a number of factors. These factors include the visibility of gestures and the display, the potential of false positive input detection, proximity to the user and the amount of physical effort required to perform gestures.

Referring again to FIG. 1A, the processing unit 14 controls the operation of the system 10 and can be any suitable processor, controller or digital signal processor that can provide sufficient processing power depending on the configuration and operational requirements of the system 10 as is known by those skilled in the art. For example, the processing unit 14 may be a high performance general processor. In alternative embodiments, the processing unit 14 may include more than one processor with each processor being configured to perform different dedicated tasks. In alternative embodiments, specialized hardware can be used to provide some of the functions provided by the processing unit 14.

The display 16 can be any suitable display that provides visual information depending on the configuration of the system 10. For instance, the display 16 can be a flat-screen monitor and the like if the form factor is that of a desktop computer. In other cases, the display 16 can be a display suitable for a laptop, a tablet or a handheld device such as an LCD-based display and the like. The display 16 may have or may not be a touch screen.

The user interface 18 may optionally include at least one of a mouse, a keyboard, a touchpad, a thumbwheel, a track-pad, a track-ball, a card-reader, voice recognition software and the like again depending on the particular implementation of the system 10. In some cases, some of these components can be integrated with one another.

The interface unit 20 can be any interface that allows the system 10 to communicate with other devices or systems. In some embodiments, the interface unit 20 may include at least one of a serial bus or a parallel bus, and a corresponding port such as a parallel port, a serial port or a USB port that provides USB connectivity. The busses may be external or internal. The busses may use at least one of a SCSI, a USB, an IEEE 1394 interface (FireWire), a Parallel ATA, a Serial ATA, a PCIe, or an InfiniBand communication protocol. Other communication protocols may be used by the bus in other embodiments. The interface unit 20 may use these busses to connect to the Internet, a Local Area Network (LAN), a Wide Area Network (WAN), a Metropolitan Area Network (WAN), a Wireless Local Area Network (WLAN), a Virtual Private Network (VPN), or a peer-to-peer network, either directly or through a modem, a router, a switch, a hub or another routing or translation device.

The I/O hardware 22 is optional and can include, but is not limited to, at least one of a microphone, a speaker, and a printer, for example.

The wireless unit 24 is optional and can be a radio that communicates utilizing the CDMA, GSM, GPRS or Bluetooth communication protocol according to standards such as IEEE 802.11a, 802.11b, 802.11g, or 802.11n. The wireless unit 24 can be used by the system 10 to communicate with other devices or computers.

The power unit 26 can be any suitable power source that provides power to the system 10 such as a power adaptor or a rechargeable battery pack depending on the implementation of the system 10 as is known by those skilled in the art.

The memory unit 28 can include RAM, ROM, one or more hard drives, one or more flash drives or some other suitable data storage elements such as disk drives, etc. The memory unit 28 may be used to store the operating system 30 and programs 32 as is commonly known by those skilled in the art. For instance, the operating system 30 provides various basic operational processes for the system 10. The programs 32 include various user programs so that a user can interact with the system to perform various functions such as, but not limited to, interacting with on-screen data and selecting off-screen data to show on the display 16 as will be described herein.

The data acquisition module 34 may be used to obtain visual spatial interaction data from the user via the motion sensor unit 44. The visual spatial interaction data can be used to measure the gestures made by the user's non-contact hand in relation to the display 16 while using the system 10. The user's non-contact hand is the hand that is moving with respect to the display 16 to move a portion of the off-screen data to the display 16 but the user's non-contact hand does not make contact with the display 16. The motion sensor unit 44 includes a motion capture device and is described in more detail below. The visual spatial interaction data is typically image data.

In some embodiments, the display 16 may be a touchscreen that can provide tactile spatial interaction data which indicates one or more contact locations on the display 16 that the user is contacting with the user's contact hand (e.g. using their finger) and well as the contact time (which Indicates how long the user is making contact with the display). The user's contact hand is the hand that is making physical contact with the display 16.

The spatial interaction module 36 receives spatial interaction data which comprises the visual spatial interaction data and the tactile spatial interaction data (if the display 16 has touchscreen capabilities). The spatial interaction module 36 analyzes the spatial interaction data to determine if the user has made a hand gesture and if so, the particular type of hand gesture (possibly including a hand contact) that was made by the user. These determinations include identifying where the user's non-contact hand and contact hand are with relation to the display 16 as well as the extent of movement of the user's non-contact and contact hands and the time duration of the user's gestures. The spatial interaction module 36 will send the detected spatial interaction data to the display output module 38.

In at least some embodiments, the spatial interaction module 36 may also defines a spatial interaction mode which dictates the type of geometric transformations that may be made to the information space to change what Is shown on the display 16. The spatial interaction modes may include at least one or more of paper distortion mode, dynamic distortion mode, point2pan mode, spatial panning mode and dynamic peephole inset mode, which will be explained in further detail below. At least one of the paper distortion and dynamic distortion modes may be modified to include content-aware distortion as explained in more detail below.

In an alternative embodiment, there may be two spatial interaction modes that are operating at the same time if the user is using both of their hands for spatial interaction with off-screen content. For example, the user's left hand may be placed in space on the left side of the display 16 and the user's right hand may be placed in space on the right side of the display 16 and the left hand may be used to operate one spatial interaction mode, and the right hand may be used to operate another spatial interaction mode. In this case, any two combinations of the Paper Distortion mode, Dynamic Distortion mode, Spatial Panning mode, or Dynamic Peephole Inset mode may work (e.g. Spatial Panning mode for the user's left hand with Paper Distortion mode for the user's right hand). If the Paper Distortion mode or the Dynamic Distortion mode is used, then either of them can be combined with content-aware distortion as well.

Initially, the display output module 38 receives initial display information (e.g., the information space) for displaying on the display 16. The initial display information is mapped to the display such that a portion of the display information is shown on the display 16, referred to herein as on-screen display information, while the other display information is mapped to one or more volumes adjacent to and outside of the display 16 and is herein referred to as off-screen display information. The adjacent volumes around the display 16 include at least one of the left volume, the right volume, the above volume, the below volume, the in front volume, the behind volume and the corner volumes including the UR corner volume, the LR corner volume, the LL corner volume and the UL corner volume.

The display output module 38 then receives the spatial interaction data and an indication of the spatial interaction mode as well as whether the user is performing a hand gesture to apply a certain geometric transformation to the information space to change what is shown on the display 16. The type of geometric transformations that may be performed include one or more of translation, compression, expansion, warping and creating inset views depending on the spatial interaction mode. The spatial interaction data may also include tactile and or time duration information indicating the length of time that the user wishes the display information to be geometrically transformed. The display output module 38 then geometrically transforms the on-screen display information so that at least a portion of the off-screen display information will be shown on the display 16. The transformed on-screen display information may be maintained on the display 16 for a time duration specified by the gesture data based on the user's hand gestures.

It should be noted that the various modules 34 to 38 may be combined or further divided into other modules. The modules 34 to 38 are typically implemented using software, but there may be some instances in which at least some of these modules are implemented using FPGA or application specific circuitry.

The databases 40 can be used to store data for the system 10 such as system settings, parameter values, and calibration data. The databases 40 may also be used to store other information required for the operation of the programs 32 or the operating system 30 such as dynamically linked libraries and the like. The databases 40 may also be used to store data logs of the user's spatial movements while using the system 10 and the resulting geometric transformations on the on-screen and off-screen content.

The system 10 may comprise at least one interface that the processing unit 14 communicates with in order to receive or send information. This interface can be the user interface 18, the interface unit 20 or the wireless unit 24. Furthermore, the spatial interactions of the user along with the transformed on-screen display information may be communicated across a network connection to a remote system for storage and/or further analysis.

A user can also provide information for system parameters that are needed for proper operation of the system 10 such as calibration information and other system operating parameters as is known by those skilled in the art. Data that is obtained from the user, as well as parameters used for operation of the system 10, may be stored in the memory unit 28. The stored data may include raw sampled spatial interaction data and processed spatial interaction data that has been analyzed to determine the gestures being used by the user, the time duration of these gestures and the resulting geometrical transformations that are applied to the on-screen and off-screen display information.

The motion sensor unit 44 includes some devices that can detect non-contact movements of the user's hand gestures when the movements are in the field of view of these devices. Any type of motion sensing device can be used as long as it is able to detect and output hand gesture data, i.e. position of the user's hand and finger tips in 3D space and the time duration of the user's gestures. In some cases, the pointing direction of the user's fingers is also obtained such as when the system 10 is operating in the Point2Pan spatial interaction mode.

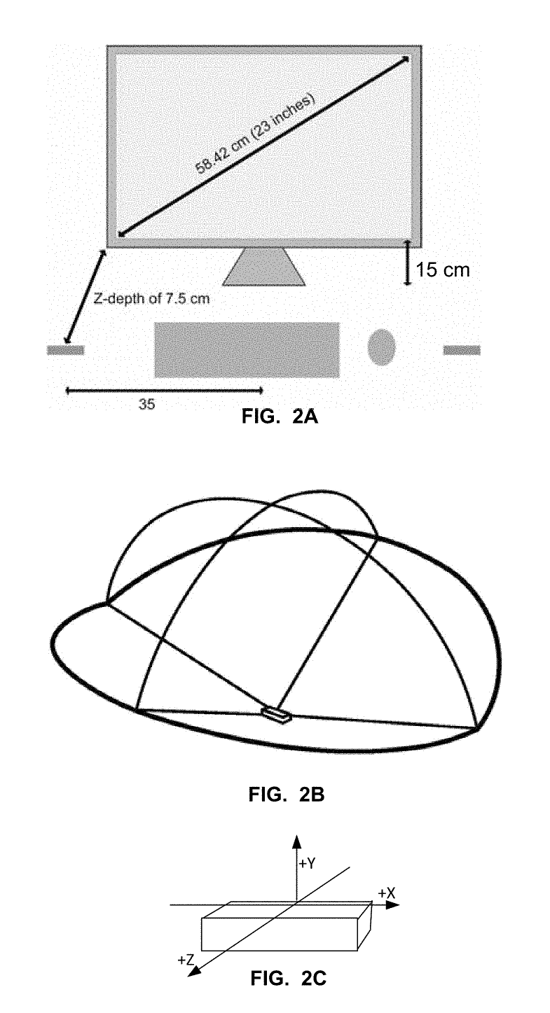

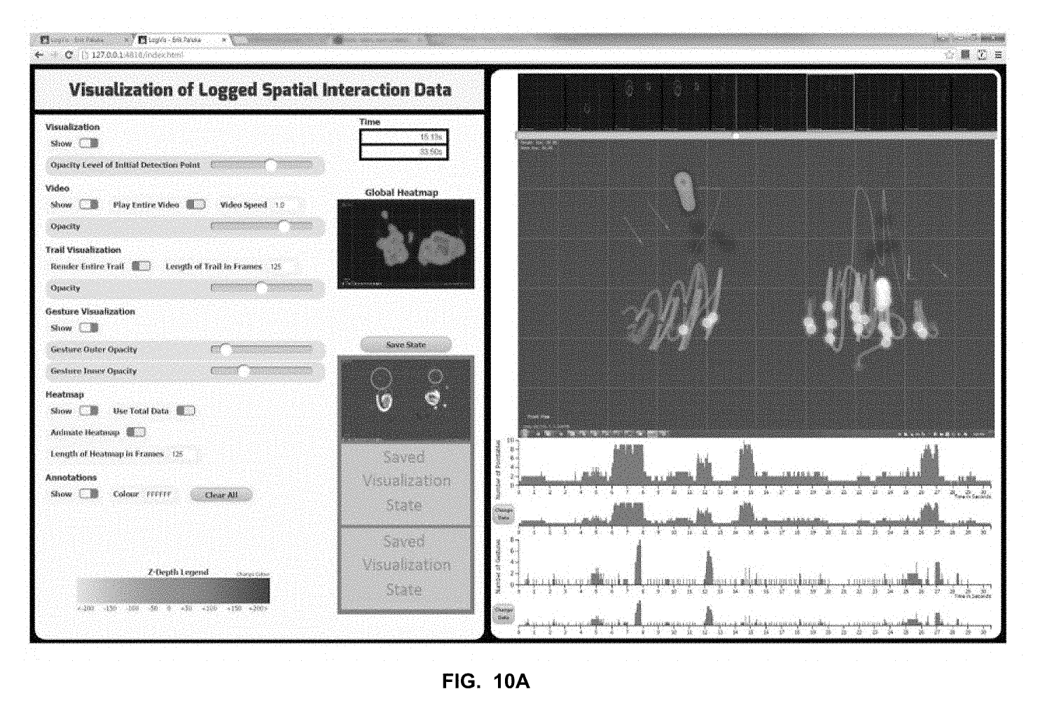

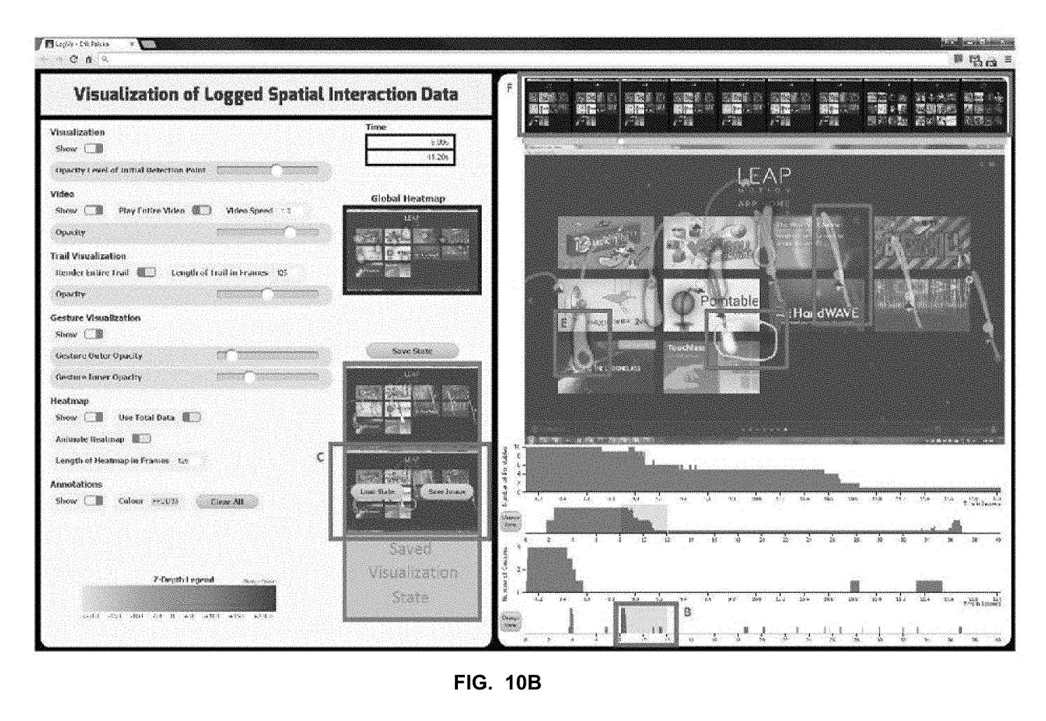

In at least one example embodiment, the motion sensor unit 44 may comprise at least one camera that monitors a majority of the volumes around the display 16 as shown in FIG. 1C using cameras C1 and C2 which are placed on either side of a keyboard and mouse collectively to monitor triangular volumes in order to detect and track the user's hand gestures. The cameras C1 and C2 may be placed a certain distance in front of the display (this dimension is referred to as the z dimension as shown in FIG. 2A for an example setup that was used for obtaining the experimental data described with respect to FIGS. 10A to 14C). The cameras C1 and C2 are used to provide the visual spatial interaction data.

Commercial equipment may be used for the spatial interaction unit, such as a leap motion controller made by Leap Motion, Inc. The leap motion controller uses two monochromatic IR cameras and three infrared LEDs to capture 3D data for monitoring an area that is approximately hemispherical in shape as shown in FIG. 2B. The coordinate system that may be used by the leap motion controller is shown in FIG. 2C. In alternative embodiments, a motion tracing system may be installed in a room, such as those created by OptiTrack or Vicon, coupled with the user wearing tracked gloves to track the users hand and finger positions in space. In some embodiments, it may be possible to use the Microsoft Kinect depth camera, although the precision may be lower.

If the display 16 is a touchscreen display then the display 16 is able to provide tactile spatial interaction data of the contacts made by the user on the display 16. Alternatively, there may be embodiments in which a touchscreen is not used so tactile spatial interaction data is not included as part of the spatial interaction data.

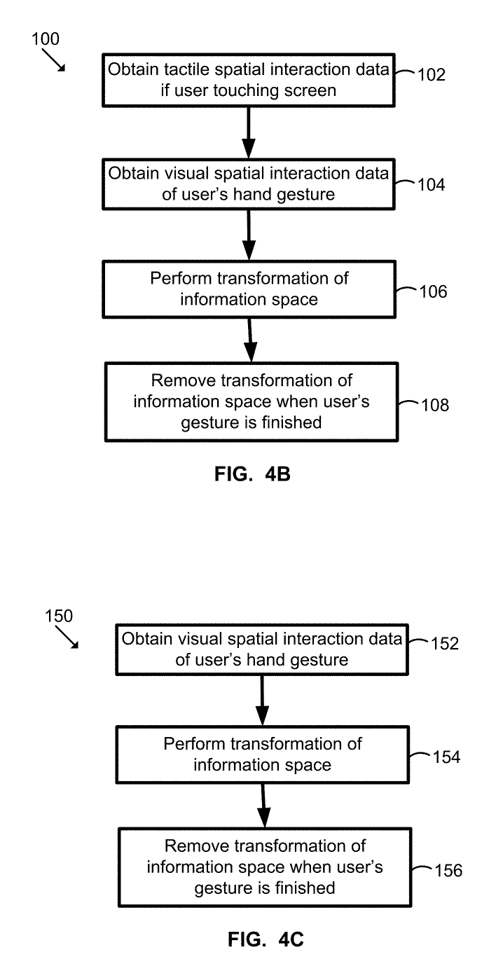

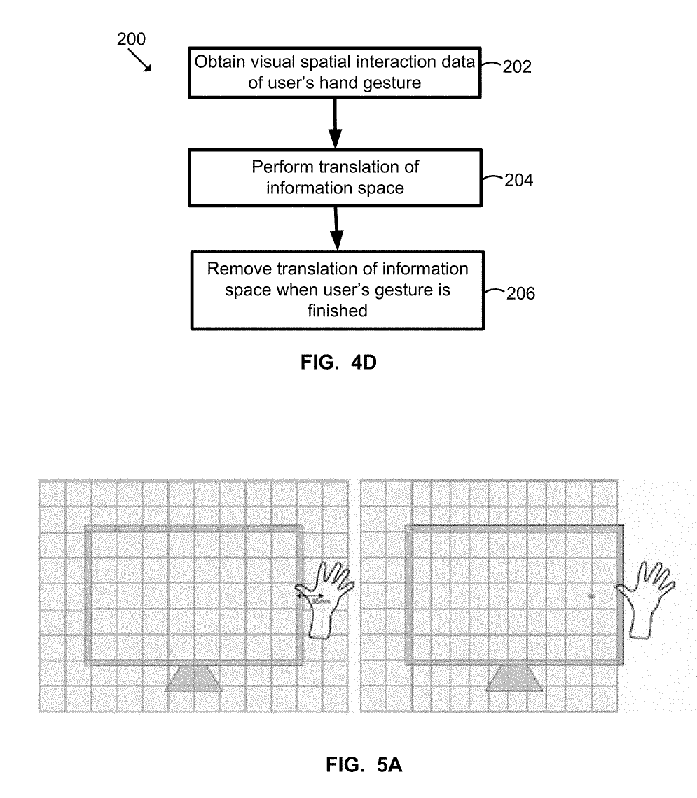

Referring now to FIG. 4A, shown therein is a flowchart of an example embodiment of a method 50 for enabling a user to spatially interact with an off-screen portion of an information space.

At 52 the method 50 sets the spatial interaction mode that is enabled by the system 100 for use by the user to view off-screen content. The spatial interaction mode may be one of the paper distortion mode, the dynamic distortion mode, the point2pan mode, the spatial panning mode and the dynamic peephole inset mode. In some embodiments, content-aware distortion may be used with one of the paper distortion mode and the dynamic distortion mode. The spatial interaction mode that is selected will determine the detection techniques that are used to detect hand gestures that correspond to the selected spatial interaction mode.

At 54, the method 50 displays a portion of the information space as image data on the display 16. The image data may be anything of interest to the user or is needed by the user to operate the system such as, but not limited to, a map image, a website, a Twitter feed, or the Windows operating system desktop, for example. The rest of the information space is mapped to the physical space that is around the display 16. The mapping may be along a certain scale with respect to the size of the image data being shown on the display 16. For example, the scale may be 1:1. In another embodiment, another mapping that may be used is to map the extent of the information space to the physical reach of the user, so if the information space was twice as big as the user's reach, then the mapping may be 2:1 (e.g. a physical movement moves×2 in information space). This design allows the user to reach the off-screen content of the entire information space more comfortably. Conversely, smaller information spaces can be mapped to larger physical spaces, allowing for more precise user interaction.

At 56, the method 50 analyzes the data provided by the motion sensor unit 44 to determine if there have been any hand gestures made by the user that corresponds to the current spatial interaction mode of operation that is enabled by the system 100. For example, in the Paper Distortion mode, when the user's hand moves towards the display 16 with a speed that surpasses a hand speed threshold (e.g. 2 cm per second), then the hand gesture is detected. As another example, in the Dynamic Distortion mode, the method 50 is monitoring a first change in the user's hand position. When this occurs it is determined if the user's hand is beside the display 16. If this is true, then the distance between the user's hand and the closest edge of the display 16 is determined and this distance is used to transform the on-screen graphics/image. The method 50 then checks if the user's hand has moved, and will continually do so until the user's hand has been removed from the side of the display 16. If the user's hand has moved, then the image on the display 16 will have to be updated (e.g. compressed further or expanded further). In the Point2Pan mode, the method 50 monitors if the user's finger (which is considered generally as a user gesture) has changed its position or direction of pointing, and if so, change the on-screen information data accordingly (in this mode the user can change either the position of their finger or its direction of pointing to change what is shown on the display 16).

Once the method 50 detects a hand gesture, the method 50 proceeds to act 58 where the geometric transformation that will be applied to the information space and the mapping of the transformed information space to the display 16 is determined. These geometric transformations depend on the spatial interaction mode that is currently enabled by the system 100. For example, for both the Paper Distortion and Dynamic Distortion spatial interaction modes, the geometric transformation involves both warping and translation while in the Point2Pan spatial interaction mode, the geometric transformation only involves translation. When the on-screen image data is compressed (in the Paper Distortion and Dynamic Distortion modes), it no longer takes up the same amount of space on the display 16, so a blank space is created, which is then filled by the off-screen image data selected by the user by translating the selected off-screen image data to the blank space. When the image data uncompresses (i.e. expands), it takes up more space, therefore other image data must be translated to make room.

At 60, the method 50 displays the transformed information space onto the display 16 according to the particular spatial interaction mode that is enabled, and the gesture characteristics of the user in terms of which off-screen information is to be displayed on the display 16.

At 62, the method 50 monitors for the user's gesture to be ended or removed at which point the non-transformed information space (i.e. the initial information space that existed before the user started making their hand gesture) is output on the display 16. In most cases, the initial image data that was on the display 16 just before the user began the hand gesture is shown again on the display 16.

However, in some cases different on-screen image data may be shown on the display 16 when the user's gesture is ended or removed since during the time interval from when the user began performing the initial hand gesture and the user ended their hand gesture, a different interaction may have occurred which changed the image data. For example, if there is an application window centered in the display 16, and there is an off-screen button that minimizes the window when selected, the user may use a hand gesture in conjunction with one of the spatial interaction modes to show the button on-screen and then select it. When the system 10 detects the removal of the user's hand and reverses the geometric transformation that was performed due to the user's previous hand gesture then the window will no longer be shown on the display q6 since it was minimized when the user was performing the hand gesture.

In an alternative embodiment, the method 50 may only reverse or undo any manipulation of the information space when it is explicitly requested to do so by the user, e.g. by the user making a gesture or a key press or interacting with another input device.

In an alternative embodiment, the method 50 may allow the user to conduct a “pinning” gesture when the hand is In the off-screen space to “lock” the view in place and allow them to remove their hand (i.e. end their hand gesture) without affecting what is shown on the display 16.

In the field of information visualization, there are seven basic tasks that visual analysts perform whilst using a visualization application. These tasks include overview, zoom, filter, details-on-demand, relate, history and extract [14]. Depending on the type of image data that is being manipulated, each of these tasks has advantages and disadvantages to them. In the case of the relate task, which is based on viewing relationships amongst items, it might be tedious to perform such a task if the items being compared cannot occupy the same display space. For example, in a typical map-based application overlaid with population data, it would be tedious to compare different sections of a small town to another town whose location is at a distance from the former. Using conventional interaction techniques, the analyst would have to zoom-in to the first small town to view the data, and then zoom-out to find the second town and zoom-in on its location to view its associated data. The problems that occur in this situation are that the flow of analysis is disrupted by requiring the user to remove the original town from the display space to view the second location, and when comparing both sets of data, the analyst is required to rely on memory.

To overcome this limitation, the descriptive framework of FIG. 3 was used to develop a set of spatial interaction techniques in accordance with the teachings herein that allows one to explore the information space situated outside the display 16, while making it easier to compare off-screen content with on-screen content. This allows the user to compare image data in a fluid manner that fits better within their flow of analysis. It also enables them to take full advantage of their advanced visual system instead of relying on memory, which is prone to errors.

While the mid-air space around the display 16 is three-dimensional, the spatial interaction techniques described herein consider the off-screen information space as being two-dimensional and defined by the plane of the display 16 (see FIG. 1B). Employing a 2D information space also reduces other problems associated with spatial and 3D user interfaces such as people having difficulty understanding 3D space (e.g., [7, 15]).

The Paper Distortion, Dynamic Distortion, Dynamic Peephole Inset, and Spatial Panning spatial interaction techniques described herein make use of direct spatial interactions (e.g., [3]) to communicate with the system 10 which part of the information space one is interested in viewing. One of the differences with the spatial interaction techniques described herein is that they may involve geometrically transforming part of the information space to bring off-screen content onto the display 16, but the information space's interaction space remains the same. Therefore, placing one's hand beside the display 16 will allow one to see off-screen content associated with that location, and then one can perform a direct spatial gesture (e.g., tap) at that same location in physical space to interact with this content. Comparison of on-screen and off-screen content is facilitated by bringing off-screen content on-screen while retaining the previous on-screen content, as seen in the Paper Distortion, Dynamic Distortion and Dynamic Peephole Inset techniques. Also, all of the applied geometric transformations may be inversed by just removing one's hand from the spatial interaction space. This facilitates comparison as well as exploration since the user can transform the information space to view off-screen content and then quickly invert this transformation to view content that was originally or previously on-screen. Even though the following explanations of these spatial interaction techniques use desktop computers, these techniques can be applied to the myriad of other device types as well.

In accordance with the teachings herein, at least one of the spatial distortion interaction techniques described in accordance with the teachings herein involves scaling down on-screen content to allow off-screen content to be shown on the display 16. This allows one to view and compare off-screen and on-screen content at the same time. It is important to note that when the on-screen content becomes distorted, comparing it with other content does become more difficult. To help mitigate this, at least one of the spatial interaction techniques described herein takes into account the energy/importance of the on-screen content to minimize the distortion of important information when off-screen content is also shown by the display 16. For example, the geometric transformation applied to a region of pixels of the initial on-screen content may be based on the information content of the regions of pixels, which may be the information density of the regions of pixels or the importance of the information in the regions of pixels, the determination of which may be predefined or defined by the user (e.g. any function on the information space may be used depending on the context). For example, the user may compress a map to remove water but keep land, or conversely to keep water and compress land. In the desktop navigation scenario, the user may distort regions of the screen containing a web browser but keep the region containing a word processor. The various spatial interaction techniques may distort the information space using the same scaling amount for each distorted section of data, but there can be other embodiments where other types of scaling techniques can be used such as, but not limited to, fisheye scaling, linear drop-off functions, and non-linear drop-off functions, as well as their combination (as described in “M. S. T. Carpendale, A Framework for Elastic Presentation Space, PhD thesis, Simon Fraser University, Vancouver, BC, Canada, 1999.”).

### Paper Distortion

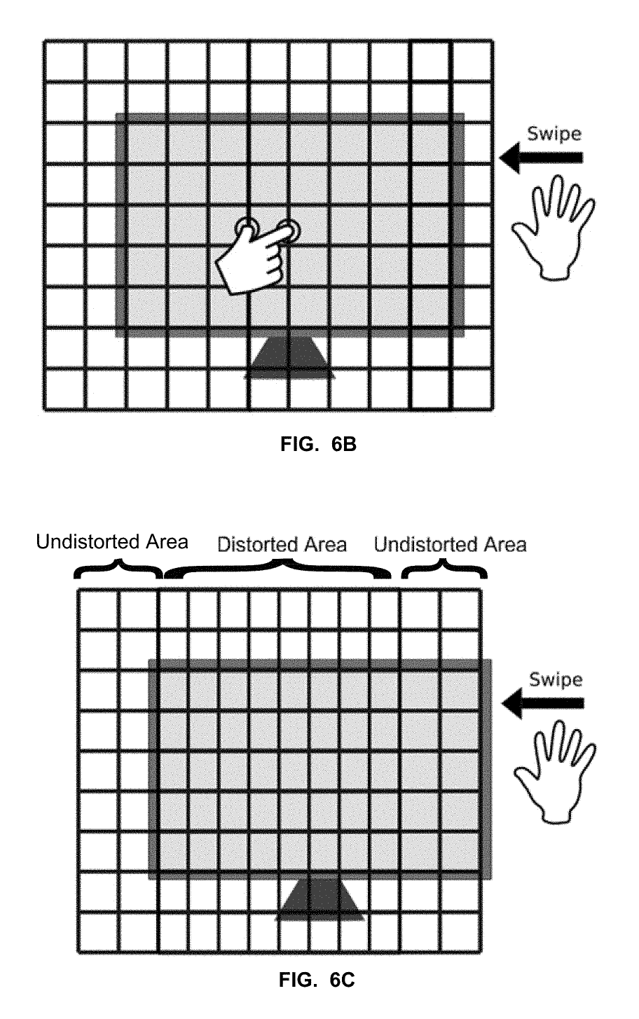

The Paper Distortion spatial interaction technique employs a paper pushing metaphor to display off-screen content. If one imagines the 2D information space as a sheet of paper that is larger than the display 16, the user can push the paper from the side towards the display 16 to bring off-screen content onto the display 16. This causes the section of paper that is over the screen of the display 16 to crumple (distort); therefore creating enough room for the off-screen content by only scaling down the on-screen content (see FIG. 6C). In this case, the entire on-screen content that was previously displayed will be distorted.

In at least one alternative embodiment of the paper distortion technique, instead of distorting all of the previous content on-screen, the user may also touch a location on the display 16 (assuming that the display 16 is a touchscreen) whilst performing the pushing gesture to select a starting point of the distortion. The end point of the distortion may automatically be selected to be the closest on-screen location to the user's performed off-screen push gesture. For example, if one pushes horizontally from the right side and touches the middle of the screen to define the starting distortion point, then only on-screen content that is on the right side of the middle of the screen (e.g. from the starting distortion point) to the edge of the display 16 which defines the ending distortion point will become distorted.

In at least one other alternative embodiment of the paper distortion technique, the user may have the option to define the end point of the on-screen content distortion. The region between the starting distortion point and the ending distortion point may be referred to as a distortion region. Accordingly, the user may touch two locations on the display 16 (assuming the display 16 is a touch screen that enables multiple simultaneous touch points) with one hand and perform the push gesture with the other hand, and only on-screen content between the starting and ending distortion points will become distorted. This technique can be performed to push off-screen content from any side or corner onto the display 16.

In at least one other alternative embodiment, the paper distortion technique may support multiple off-screen areas (e.g., the left and right sides) being pushed onto the display at the same time. When the user removes their hand from the interaction space (i.e. the physical space around the display), this technique can optionally keep the off-screen content on-screen or automatically reset the information space. If off-screen content is kept on-screen, the user can perform the opposite spatial gesture (push the “paper” out from the side of the display 16) to move the off-screen content back to its original off-screen location.

Referring now to FIG. 4B, shown therein is a flowchart of an example embodiment of a method 100 for implementing a paper distortion spatial interaction technique in accordance with the teachings herein. The paper Distortion technique may distort (i.e. scale or compress) the entire information space that resides on-screen, or a subsection thereof, to bring off-screen content within the screen of the display 16. This creates a gap for the on-screen information which is filled by translating the appropriate off-screen section of the information space.

To perform the paper distortion spatial interaction technique, a user places their hand in the air beside the display 16 and swipes in the direction of the display 16. If a touch-screen monitor is employed as the display 16, the user can decide to only compress a subsection of the on-screen section of the information space. This is accomplished by the user by touching the display 16 to define the start of the section of on-screen content that the user wishes to be compressed. The user also has the option to select the end of the section of on-screen content that gets compressed by touching the display 16 at another location.

Alternatively, in at least one embodiment of the Paper Distortion spatial interaction technique, the user's hand can move anywhere in a given quadrant beside the display 16 since the compression effects do not change after the user makes the initial swipe gesture.

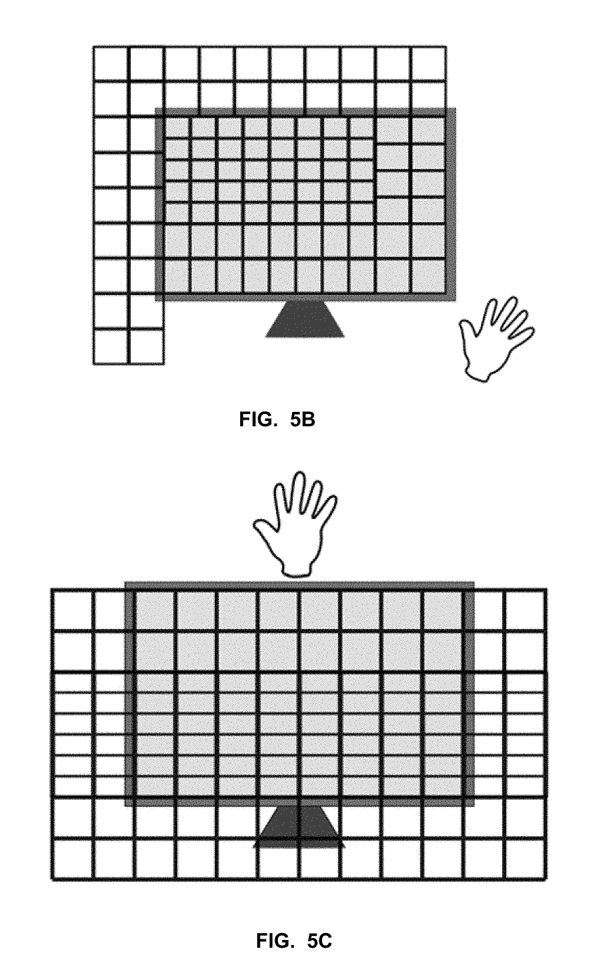

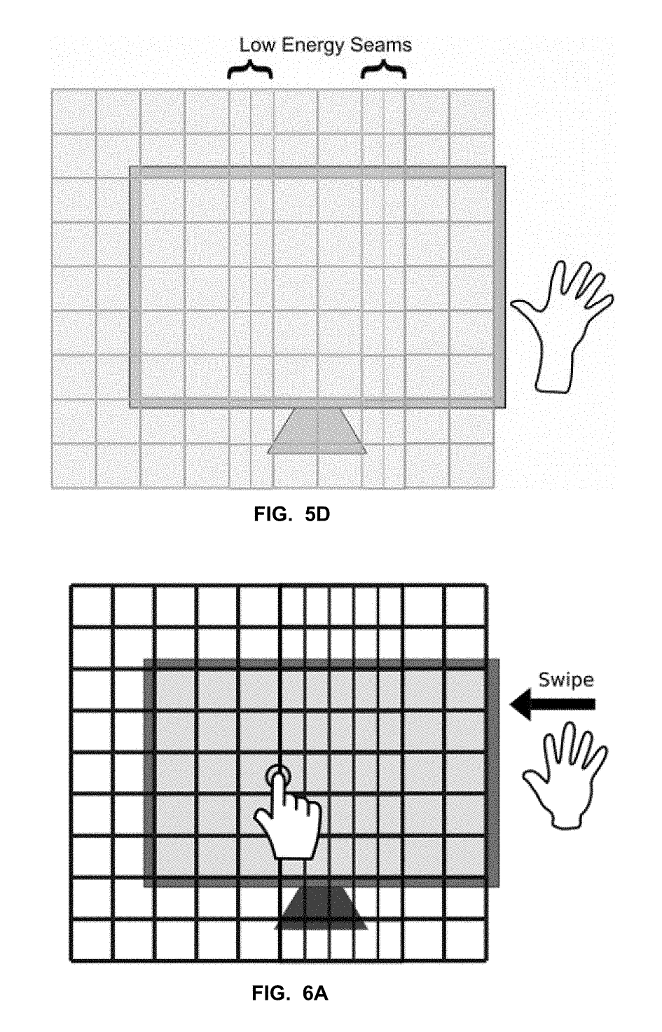

Accordingly, in one example embodiment, at 102, the method 100 obtains tactile spatial interaction data if the user is touching the display 16 and the display 16 is a touchscreen. The tactile spatial interaction data may contain one or two finger contact points that define a distortion starting point and a distortion ending point, respectively, as described previously. The distortion starting point defines the beginning of the on-screen information space that gets compressed (e.g. all of the information space to the right of the distortion starting point to the right edge of the display 16 or to the distortion ending point (if the user made a second finger contact with the display 16) if the user is making a mid-air (i.e. non-contact hand) gesture to the right of the display 16 as is shown in FIGS. 6A and 6B, respectively. Alternatively, if the user makes a mid-air gesture to the left of the display 16 then the distortion starting point defines the beginning of the on-screen information space that gets compressed to the left edge of the display 16 or to the distortion ending point (if the user made a second finger contact with the display 16). Alternatively, the distortion starting point and the distortion ending point, if there are any, may define the vertical point(s) at which to apply the apply the compression if the user is making a vertical hand gesture above or below the display 16. Therefore, if there is only a distortion starting point, then the on-screen information space between the distortion starting point and the edge of the display 16 that is adjacent to the user's hand gesture will get compressed. Alternatively, if there is also a distortion ending point, then the on-screen information space between the distortion starting point and the distortion ending point gets compressed in the direction of the user's hand gesture. For example, horizontal compression occurs when the user makes hand gestures to the right or left of the display 16 and vertical compression occurs when the user makes hand gestures to the top or bottom of the display 16. Alternatively, both horizontal and vertical compression may occur if the user is making hand gestures to the corner of the display 16 (i.e. a diagonal swiping motion), an example of which is shown in FIG. 5B, in which case the distortion staring point defines the area of the on-screen information space that gets distorted to the opposite corner of the display (or to the distortion ending point if there is one) relative to the other corner of the display 168 that is adjacent to where the user is making the hand gesture. It should be noted that there may be an alternative distortion that is applied compared to what is shown in FIG. 5B. The alternative distortion involves distorting the lower left of the grid upwards. Accordingly, in some embodiments, only the on-screen section of the information space is distorted as shown in FIG. 5B, while in other embodiments, the sections of the information space that lie outside of the screen's view is also distorted.

At 104, the method 100 obtains visual spatial interaction data of the user's hand gesture. Act 104 may be done concurrently with act 102. The user's hand gesture comprises the user placing their hand past a side of the display 16 (e.g. top, bottom, left, right, UL, UR, LR or LL) and performing a swiping gesture towards the display 16. The swiping motion of the user's gesture is detected if the user's hand is moving faster than a hand speed threshold, such as about 1 cm per second. In some embodiments, this threshold may be varied based on the size of and distance from the information display or user preference. In some embodiments, the threshold may vary depending on the direction of swiping in which case the threshold is a velocity threshold.

At 106, the method 100 performs a transformation of the information space. The transformation depends on whether the user has also defined a starting distortion point and/or ending distortion point as explained with act 102. The on-screen information space gets compressed leaving empty space on the display 16 that is filled with the image data that corresponds to the selected off-screen information space that is under the user's hand when they are performing the hand gesture. In some embodiments, the selected off-screen information space may be output on the display 16 in a non-compressed fashion.

Alternatively, in some embodiments, the selected off-screen information space may be output on the display 16 in a compressed fashion using the same compression factor as was applied when the on-screen information space was compressed or a different compression factor may be used for putting the selected off-screen information space on the display 16.

Alternatively, in some embodiments, a different compression or warping technique may be used for the off-screen information space that is brought on-screen (e.g. a different linear drop-off function or a non-linear drop off function, or a combination thereof).

Alternatively, the amount of compression that is applied may depend on the relative sizes of the on-screen and off-screen information spaces. For example, if the user swipes their hand towards the right of the display 16 and if the right side's off-screen section of the information space is smaller than the width of the display 16, then the on-screen section only has to be compressed a little bit to be able to make enough room for the off-screen section. Alternatively, if the selected off-screen information space is the same width of the display 16 or larger, then the on-screen information space may have to be compressed to less than a pixel wide.

When the user touches the display 16 to denote the start (and possibly the end) of the on-screen section of the information space that will be compressed, then instead of basing the amount of compression on the width of the display 16, it may be based on the width of the on-screen section that has been denoted by the user. For example, if two fingers are touching the display 16 when the mid-air swiping gesture is being performed, then the horizontal distance between the fingers is the width. If only one finger is touching the display 16, then the width is the horizontal distance between the finger location and the right side of the display if the user's hand is in the space to the right of the display 16.

In some embodiments, the amount of compression is similar in the cases where the user is making a vertical swiping motion or a diagonal swiping motion. For example, if the user's hand was above the display 16 and a swiping motion was performed down towards the display 16, then the on-screen section of the information space will be compressed vertically. The amount of compression may be based on the height of the display 16, or if the user is also touching the display 16 with two fingers the amount of compression may be based on the vertical distance between the user's two contact points, or if the user is touching the display 16 with one finger the amount of compression may be based on the vertical distance between the user's one finger contact point and the top of the display 16.

At 108, the method 100 detects that the user's hand gesture is finished and removes the transformation of the information space which involves removing the off-screen information space that was placed on the display 16 at act 106 and also expanding the compressed on-screen information space so that the on-screen information space that was shown on the display 16 before the user began the hand gesture is now shown on the display 16. The user's hand gesture may be finished when the user removes their hand from the side of the display 16, or when the user performs a swiping gesture away from the display 16 using the same hand.

### Dynamic Distortion

The Dynamic Distortion technique is similar to the Paper Distortion technique in regards to distorting the on-screen content to make room for off-screen content that is selected by the user to be shown on the display 16. Whereas in the Paper Distortion spatial interaction technique a singular swipe gesture may be used at the side of the display 16 to activate the distortion, with the Dynamic Distortion spatial interaction technique the user may be able to continuously change the amount of distortion by adjusting their hand location in relation to the side of the display 16. To invoke this technique, the user places their hand in an off-screen area, which causes the system 10 to determine the section of the off-screen information space that is being touched (i.e. selected) by the user's hand. A direct 1:1 mapping between the physical space and the information space may be used to accomplish this (other mappings may be used in other embodiments). The system 10 then updates the information to output on the display 16 by distorting the on-screen content to bring the selected off-screen information onto the display 16. By moving one's hand further away from the side of the display 16, the amount of distortion increases (i.e. a higher scale ratio is used) since more of the off-screen information space needs to fit on-screen. To be able to view off-screen content past the corner of the display 16, the on-screen content may be distorted horizontally and vertically as shown in FIG. 5B. This dynamic distortion spatial interaction technique may be configured in at least one embodiment to occur only when a user's hand is above or below the display 16, while also being beside the display 16. FIG. 3 shows the areas 1, 3, 5 and 7 of the off-screen space that trigger the different distortions when a user's hand is in one of those off-screen areas or regions. The user may move their hand above or below the display 16 in off-screen areas 2 and 6, respectively, to trigger vertical distortions of the on-screen content. Alternatively, the user may move their hand to the left or right areas 8 and 4 to trigger horizontal distortions of the on-screen content. Alternatively, the user may move their hand to one of the corner areas 1, 3, 5 and 7 to trigger both horizontal and vertical distortions of the on-screen content.

Referring now to FIG. 4C, shown therein is a flowchart of an example embodiment of a method 150 for enabling a dynamic distortion spatial interaction technique in accordance with the teachings herein.

At 152, the method 150 obtains visual spatial interaction data of the user's hand gesture. The user may place their hand past a side (top, top right corner, right, bottom right corner, bottom, bottom left corner, left, or top left corner) of the display 16 which is detected. The distance between the user's hand and the closest side or corner of the display 16, as the case may be is also determined.

At 154, the method 150 performs a transformation of the on-screen and off-screen information spaces. In one embodiment, only the on-screen section of the information space may get compressed/scaled down to create a blank space (i.e. make room) for the off-screen section of the information space that is selected by the user which is the off-screen information space that is between the edge of the display 16 that is closest to the user's hand to the off-screen information space that is underneath the user's hand. However, in an alternative embodiment, both the on-screen information space and the off-screen information space may be compressed. The selected off-screen information space is translated onto the blank space of the display 16. An example of this is shown in FIG. 5C. The compression is dynamic meaning that the compression is continually updated based on the distance of the user's hand from the closest edge of the display 16. The farther that the user moves their hand away from this edge of the display 16 then the greater the amount of compression that is applied to the on-screen information space and the greater the amount of the off-screen information space that gets translated onto the display 16. Conversely, if the user moves their hand closer to the display 16, then the on-screen information space will become less compressed. If the user's hand is in the top, or bottom space around the display 16, then only vertical compression may be used. If the user's hand is in the right or left space around the display 16, then only horizontal compression may be used.

If the user's hand is in a corner space, then the on-screen section of the information space will be compressed vertically and/or horizontally. For example, if the user's hand is in a corner space, then moving vertically closer/farther from the display 16 while maintaining the same horizontal distance will cause only the vertical compression to change. Conversely, if the user's hand is in a corner space and the vertical distance is maintained but the horizontal distance changes, then only the horizontal compression will change.

At 156, the method 150 removes the transformation of the information space when the user's gesture is finished. For example, the on-screen section of the information space becomes uncompressed when the user moves their hand far enough from the side or corner of the display 16 that the user was interacting with such that the motion sensor unit 44 can no longer sense the user's hand position. As another example, the user may remove their hand from an off-screen interaction volume.

### Content-Aware Distortion

At least one of the embodiments of the spatial interaction techniques described herein may employ Content-Aware Distortion to manipulate how the on-screen information space is transformed. This may be done by determining the energy or importance of each pixel, and selecting the low energy pixels for distortion (see FIG. 5D). Distortions may be applied to entire strips, seams or other regions of pixels to reduce the possibility of shearing the high energy content. To calculate the energy of a pixel or a region of pixels, one or more aspects of the information space may be used, such as the density or importance of the information at each location. In at least some embodiments, on-screen regions with a high amount of energy may only be translated (i.e. shifted), whereas on-screen regions with a low amount of energy may be scaled down (e.g. compressed) to make room for the selected off-screen content. For example, in a map-based interface showing some land masses and oceans, if the pixels representing the oceans has low energy, then the Content-Aware Distortion technique may only distort the on-screen areas having the oceans. At the same time, on-screen portions having continents with high energy can be translated and not distorted. The content-aware distortion technique may be used with either the Paper Distortion or the Dynamic Distortion techniques to provide the user with minimal loss of important information.

### Dynamic Peephole Inset

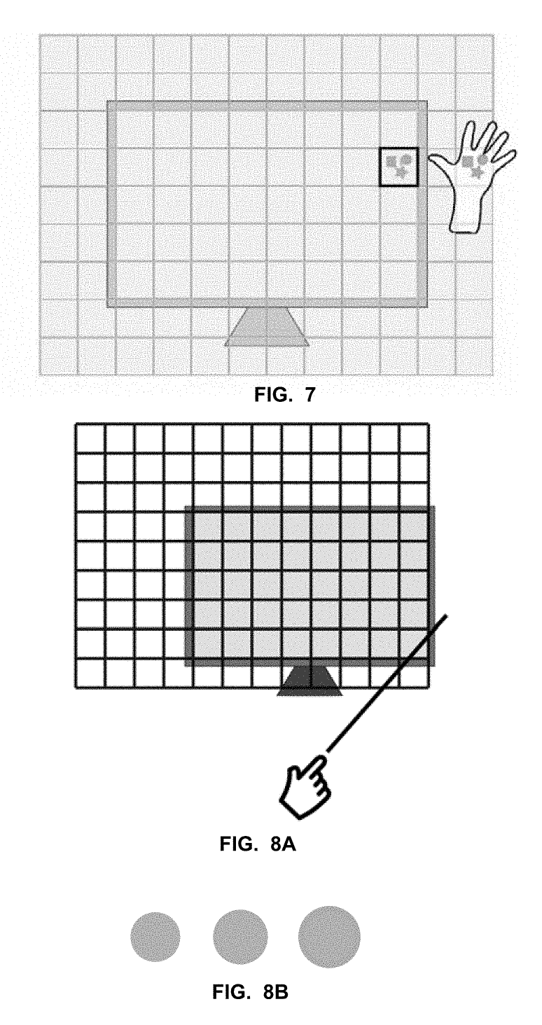

The Dynamic Peephole Inset spatial interaction technique uses the position of the user's hand in the off-screen information space and displays the corresponding content in an inset/viewport that is situated on-screen at the edge of the display 16 (see FIG. 7). This allows one to easily explore the off-screen information space by moving one's hand around the display 10. There are many options for the placement of the viewport on-screen. The viewport can be fixed at the closest corner of the display 16 to the user's hand, the centre of the closest edge of the display 16 to the user's hand, or continuously follow the location of the user's hand.

The Dynamic Peephole Inset technique supports different mappings between the location of the user's hand and the corresponding off-screen content shown within the viewport. These mappings include direct, normalized, semi-normalized, normalized (based on the side of the display 16), content-aware, and dynamic.

In direct mapping, the content that is displayed within the viewport is the section of the off-screen information space that is directly underneath the user's hand, as seen in FIG. 7. Therefore, the direct mapping has a 1:1 mapping.

In normalized mapping, the off-screen information space is mapped using a predefined interaction space beside the display 16. This way, entire information spaces of any size can be explored by the user by using the available interaction space, simply by reaching out his/her hand, without clutching or panning the display. However, the input gain increases with larger information spaces, making precise navigation more difficult. The size of the interaction space is usually based on practical limitations such as the field of view of the motion sensing unit 44. Another option is to base the interaction space on anthropometric data (e.g., the average length of a user's arm) to increase usability and reduce negative effects such as gorilla-arm (i.e. excessive fatigue) [6].

The semi-normalized mapping depends on which side of the display 16 the user's hand is located in. If the user's hand is located on the left side or the right side of the display 16, then the vertical location of the user's hand has a direct 1:1 mapping to the information space, but the horizontal location is normalized using a predefined interaction space. If the user's hand is located above or below the display 16, then the reverse is true.

The normalization based on the side of the display 16 mapping takes a similar approach where if the user's hand Is on the left or right side of the display 16 and within the vertical boundaries of the display 16, then there is a vertical 1:1 direct mapping with a horizontal normalized mapping. If the user's hand goes outside the vertical boundaries of the display 16, then the vertical mapping becomes normalized as well. If the user's hand is above or below the display 16 and within the horizontal boundaries of the display 16, then there is a horizontal 1:1 direct mapping and a vertical normalized mapping. When the user's hand goes outside the display's horizontal boundaries then the horizontal mapping becomes normalized.

The content-aware mapping is a little different from the aforementioned mapping techniques. It utilizes the same energy function approach as the Content-Aware Distortion technique described above, but instead of distorting the information, the viewport uses a friction metaphor for movement. Information areas with high energy have an associated high friction value and information areas with low energy have a low friction value. Therefore, when the user moves their hand past a certain speed threshold, such as 2 cm per second for example, then the viewport moves at a higher speed when moving through low energy areas of an information space and slows down when a high energy area of an information space is reached. The speed threshold is used to allow the user to intentionally investigate low energy areas without skipping over them. This content-aware input gain Is designed to balance precision as well as speed of access for large information spaces within the constrained interaction space of the sensor and the user's reach limitations. Using the previous ocean example, this mapping may allow one to spend less time traversing the water regions of the map while searching for other continents (i.e. areas of interests).

In dynamic mapping, the user is able to dynamically change how their hand's XY location is mapped to the information space. By moving one's hand farther away from themselves along the Z-axis (i.e. deeper into the plane of interaction), the input gain increases. The opposite motion decreases the input gain. This gives the user precise control over how the information space is explored with the option to change the mapping at any time.

### Spatial Panning

The Spatial Panning interaction technique translates (pans) the information space to show off-screen content with the use of two different mappings: direct or normalized. In Direct Spatial Panning, the off-screen location of interest is indicated by the location of the user's hand using a direct 1:1 mapping. By directly placing one's hand in the information space that resides off-screen, the system 10 will translate the environment to show on-screen the information space that is located at the position of the user's hand. For example, on the right side of the display 16, the vertical panning amount can be determined based on the distance between the user's hand and the vertical centre of the display 16. Similarly, the horizontal panning amount may be determined based on the distance between the user's hand and the right side of the display 16. As with the normalized mapping in the Dynamic Peephole Inset mode, Normalized Spatial Panning maps the entire associated off-screen information space to a predefined interaction space beside the display 16 to allow any sized information space to be comfortably explored.

### Point2Pan

Point2Pan is a ray-casting technique where a user points to a section of the information space that lies off-screen, and the display 16 translates (pans) the information space to show this off-screen section on-screen. An example of this Is shown In FIG. 8A. The user may manipulate the content using touch or the mouse for example, or end the pointing gesture to translate the information space back to its original location. This allows one to quickly explore the surrounding off-screen area without much physical effort. This can be accomplished by finding the point of intersection between the plane that is defined by the display 16 and the infinite line specified by the direction of the finger as shown below.

Plane equation: (p−p₀)·n=0 (1)

Line equation: p=dl+l₀ (2)

Substituting equation 2 into equation 1 and solving for d:

$$d = \frac{( {p}_{0} - {l}_{0} ) \cdot n}{l \cdot n} \qquad ( 3 )$$

where d is a scalar, p₀ is a point on the plane, l₀ is a point on the line, n is a normal vector of the plane, p is a set of points, and l is a vector in the direction of the line. If l·n=0 then the line and the plane are parallel. If l·n≠0 then there is a single point of intersection, which is given by equation 4.

Point of Intersection=dl+l₀ (4)

Referring now to FIG. 4D, shown therein is a flowchart of an example embodiment of a method 200 for enabling a point2pan spatial interaction technique in accordance with the teachings herein.

At 202, the method 200 obtains visual spatial interaction data of user's hand gesture. In this case, the user points at an off-screen section of the information space. The method 200 detects this gesture and then calculates the off-screen position of interest that the user is pointing to by finding the intersection between the infinite line defined by the tip of the user's finger (i.e. its position in 3D space and its pointing direction) and the plane defined by the information space (e.g. the Z position of display 16) as explained above.

At 204, the method 200 performs a translation of the information space. The method 200 then translates the information space at the indicated point of interest to be centered on the display 16. This technique is dynamic meaning that the off-screen point of interest can be changed at any time when the user points in a new direction since the method 200 is always monitoring to determine if there is a change in the position of the user's hand. If the user's hand has moved and points to a new portion of the information space, then the method 200 updates the compression/expansion effects with the new data. For example, if the user previously pointed to an off-screen section and this off-screen section of the information space is translated to be the on-screen information space on the display 16, then if the user points at the display 16, the original on-screen content (or a part thereof) will be translated back onto the display. Accordingly, this technique requires defining a mapping for the entire information space that is centered on the display 16 and then translating the entire information space so that the point of interest indicated by the user's gesture (i.e. pointed finger) is at the centre of the display 16.

In some embodiments, the user has to keep their finger pointed at a desired location for as long as the user wants to have the on-screen information centered at this location. Alternatively, in some embodiments, the user may be able to make another gesture (such as closing their first) to keep the on-screen information space centered on this new position. In some embodiments, a time duration may be tied to this additional user gesture so that the new on-screen information is maintained for this time duration after the user stops making this additional user gesture and then the on-screen information reverts to what was previously displayed.

At 206, the method 200 removes the translation of the information space when the user's gesture is finished. In other words, the method 200 untranslates (i.e. centres the original on-screen content on the display 16) when the user collapses their finger (i.e. no fingers are pointing), or removes their hand from the field of view of the motion sensing unit 44.

Off-Screen System for Interacting with Off-Screen Information Space

In an example embodiment there is provided an off-screen system that enables users to interact with the off-screen information space. The off-screen system is a multimodal 2D zoomable user interface (ZUI) that enables the manipulation of on-screen and off-screen objects (i.e. objects in the on-screen and off-screen information spaces respectively). To accomplish this, at least one of the spatial off-screen exploration techniques described in accordance with the teachings herein is provided by the off-screen system along with support for spatial, mouse and touch-based selection. These different input modalities were enabled with the use of consumer-grade motion sensing hardware, a touch-enabled monitor, a keyboard, and a mouse (see FIG. 1C).

The off-screen system enabled use of the at least one of the off-screen exploration techniques on the left and right side of the display. Movements in the volumes above, below, in front and behind the display were not supported in this example embodiment but may be used in other embodiments. The above display space has a high potential for causing excessive fatigue in users, and the distance between this space and the keyboard/mouse is large. The space below the display was not supported since it has a high risk of unintentional input due to the keyboard/mouse being close by. Also, the vertical height of this space is typically small; therefore it only supports directly interacting with small information spaces. The off-screen exploration techniques did not make use of the interaction space in front of the display since it does not support directly interacting with a 2D information space that is defined by the plane of the display, and it has a very high risk of unintentional input. Behind the display space does not support the aforementioned direct off-screen interaction as well, and performing gestures within this space is difficult. This is due to the display occluding the view of gestures and the user having to reach around the display to interact within this space. The left and right side spaces adjacent the display were the best choices for supporting off-screen interaction since they are close to the keyboard and mouse, the risk of unintended interaction in this space is low, users are comfortable interacting in this space, and these spaces support direct spatial interaction with a 2D information space that is defined by the plane of the display.

This off-screen interaction system may be implemented using the Java programming language. To reduce coding complexity, the Processing library was used due to it having a simplified syntax and graphics programming model [13]. Different spatial interaction techniques are supported through the integration of a multi-touch-enabled monitor, motion sensing hardware, and a mouse and keyboard (see FIG. 1C). To allow low level control of the touch information, all touch interactions were programmed based on touch position and time data that was received using the TUIO protocol [9].

To enable spatial interaction, two Leap Motion controllers (Leap) [11] were used, one for each side of the touch-enabled computer monitor (see FIG. 1C). A Leap motion controller is a Universal Serial Bus (USB) based peripheral device that contains three infrared (IR) light-emitting diodes (LEDs) and two monochromatic IR cameras [2]. The LEDs emit IR light into the space above the display which reflect off of objects or limbs in that space. This reflected light is then captured by the cameras C1 and C2 and sent to the computer for analysis. A 3D representation of the captured Image data is then constructed to be able to extract tracking information. The interaction space of each Leap is shaped like an inverted pyramid (see FIG. 2B) and has a height of 60 cm (2 feet) with a total volume of 0.2265 cubic meters (eight cubic feet).

The motion sensing device that was used can detect and track multiple hands and fingers, as well as thin cylindrical objects (e.g. tools). It also has support for detecting certain user hand or figure gestures including tracing a circle with a finger (Circle), a long linear movement of a hand and its fingers (Swipe), a downwards finger tap (Key Tap) and a forwards finger tap (Screen Tap). The motion sensing device may use a right-handed Cartesian coordinate system with its origin centered directly on top of itself and with positive Z-axis values increasing towards the user (see FIG. 2C). With relation to tracked entitles, the off-screen system can provide developers with velocity and positional data, among many other types of information. Custom touch interactions software was developed and used for performing specific spatial interaction techniques according to the teachings herein.

### Using Multiple Leap Motion Controllers on the Same Computer

At the time of this writing, Leap Motion's software did not allow two Leap motion controllers to be connected and used simultaneously on the same computer. To get around this problem, another computer may be used for capturing the data from the second Leap motion controller and sending it over a network to a host computer. Instead of using additional hardware, Leap Motion's software was installed on a Linux virtual machine which was given control of the second Leap. The captured data was then sent to the host operating system using the WebSockets protocol, and a WebSockets client was integrated into the off-screen system to be able to receive it. To reduce code complexity and redundancy, a wrapper was also developed to be able to encapsulate the data received over the network and the local Leap data with only one set of data structures.

### Calibrating Multiple Motion Sensors for Off-Screen Interaction

Leap motion controllers are typically used within a standard desktop computer configuration and do not require calibration if they are centered horizontally with respect to the desktop's display (i.e. monitor). This is because the Leap SDK provides functions to automatically map its interaction space to the size of the display. To properly map spatial data in the off-screen system, the location of each Leap motion controller with respect to the display was used. To accomplish this, a calibration mode was created that contains a touch-enabled target at each corner of the display and a circular progress bar for feedback. When the user directly touches a target with their finger, the system gathers positional data associated with the user finger from each Leap motion controller. Since each Leap's centre of origin is on top of itself, the distance from the touched corner of the display to each Leap motion controller can be determined from this positional data. The user may touch the target and hold their finger in this position for ten seconds so that the data can be averaged over time with the aim of increasing the precision of the final result. To determine if a corner of the screen is outside of a Leap's field of view, the system may query the Leap to see if it detects a hand when a corner of the display is being touched. This calibration technique does contain one caveat: the user must only use one hand at a time with only one finger extended during the calibration process or else the Leaps might gather data from the wrong user finger.

To reduce programming complexity, this information was used to transform the Leap data from its local frame of reference into a global frame of reference (i.e. coordinate system). This is accomplished by querying the display to automatically determine the size of the display from resolution and pixel density data. The display size and data from the calibration mode may then be used to determine the distance of each Leap with respect to the bottom left corner of the display. These distance values are then used in a model to convert the Leap positional data, as it enters the system, into a global coordinate system.

### Visualization of Off-Screen Content

To provide the user with knowledge of off-screen content without requiring the user to explore the off-screen information space with spatial, mouse, or touch-based interactions, a set of visualization techniques may be integrated into the off-screen system. These include Wedge [4], overview+detail, arrows, EdgeRadar [5], Halo [1,] and City Lights [17]. EdgeRadar displays miniaturized versions of the off-screen objects in bands located at the edge of the display. Each band represents part of the off-screen information space. For each off-screen object, Halo displays a circle that is centered at the object's location. The City Lights visualization technique draws semi-transparent thick lines at the edge of the display 16 to represent off-screen content. The lengths of the lines depend on the actual size of the objects.

When the overview+detail visualization is displayed and the information space has been distorted, the visualization's viewfinder will change its size to update what sections of the information space are located on-screen. Since all of the aforementioned visualizations take up screen space, a spatial user gesture has also been included that visualizes off-screen content on-demand. When a user closes their hand into a fist, all objects that lie off-screen are visualized at the edge of the screen. This technique saves screen space since the visualization only occurs when a fist is made. Performing the opposite action (the user opening their hand) removes the visualization. This allows one to quickly view the state of all off-screen objects, as well as determine the sections of the information space that they lie within.

Interacting with OffScreen Content

To enable offscreen interaction, at least some of the off-screen exploration techniques were integrated with different selection techniques. Along with mouse and touch-based selection, panning was also supported using these modalities.

Since the off-screen exploration techniques temporally move content on-screen, in at least one embodiment a spatial user gesture that pans the information space to permanently bring content on-screen was also supported. This spatial user gesture can be performed when the user only extends their thumb and pinky and moves their hand. The information space will pan based on the distance moved and the velocity of the user hand gesture. When the user makes this hand gesture at a faster speed, the gain of the interaction will increase, thus allowing the user to pan large distances with quick and short hand movements.

In at least one embodiment, the zoom level can also be changed to bring off-screen content on-screen. This can be performed by double clicking on an empty part of the information space with the mouse, using the mouse's scroll wheel, or by performing a spatial user gesture. This spatial user gesture may be performed when the user surpasses a velocity threshold along the Z-axis with a closed fist.

To select objects, users may position the cursor (pointer) over an object, which will highlight the target, and perform a selection technique. Mouse clicking, touch, key press (e.g., spacebar), and two spatial gestures that are described in the section below were enabled with the off-screen system. When selected, these objects can be moved around the information space by using the modality that was employed to select the object (i.e., by moving the mouse, by moving the user finger on the display, or by the user moving their hand in mid-air). If an object is moved into a part of the information space that has been distorted, the object may be distorted when released from the cursor. To deselect the object, a similar technique to the one employed for selection may be performed (e.g., releasing the mouse button, removing the finger from the display, etc.). Although the off-screen exploration techniques were only supported in the left and right around-display interaction volumes, in this example embodiment, spatial selection of objects in front of the display was also supported to be able to move on-screen content off-screen with spatial interaction.

When attempting to view non-existent off-screen content that is past a boundary of a finite sized information space, the off-screen system may display a semi-transparent red band on the appropriate edge of that information space. This informs the user that they have reached the edge of the information space and that no more content lies past it. With the Dynamic Peephole Inset interaction method, this red band appears in its viewport.

### Spatial Selection

All of the spatial interaction techniques support selecting off-screen objects using spatial gestures except for the Point2Pan and Paper Distortion techniques. The Point2Pan technique does not support spatial selection since this off-screen exploration technique translates (i.e. pans) the information space based on the direction that the user's finger tip is pointing. Therefore, when the user performs a gesture with their finger or hand the information space may translate before a selection can be made. However, spatial selection with the Paper Distortion technique is possible if desired.

The spatial selection techniques that were supported by the off-screen system include the user making a mid-air tap with one of their fingers and a mid-air grab with one of their whole hands. Once selected, off-screen objects can be moved around the information space when the user moves their hand. If the finger-based selection technique was employed to select an object, deselection may occur when the user performs another mid-air tap with their finger. With the spatial grab gesture, deselection may occur when the user opens their hand. To be able to select objects with these techniques, an on-screen cursor (pointer) may be required to inform the user what part of the information space will respond to their spatial input. The design of the off-screen system's spatial cursor, as well as other aspects related to spatial selection, is described in the sections below.

### On-Screen Spatial Pointer

When a user places their hand beside the display, off-screen content is brought on-screen and a circular cursor (i.e. pointer), which may be colored, representing the users hand may be displayed within the section of the information space that is mapped to the user's hand's physical location. The cursor's position In the information space is based on the horizontal and vertical position of the users hand with respect to the display, the size of the information space and what geometric transformations have been performed on it, the screen size and its resolution, and which off-screen exploration technique and mapping is being used. For example with direct mapping, if the user's hand was on the right side of the display, was vertically centered with the screen and there was a horizontal distance of 95 mm between the centre of the user's palm and the rightmost screen pixel, then the off-screen system can determine what part of the information space the user's hand is covering if the screen was large enough to display it. In contrast, the screen's right side needs to be more than 95 mm wider to view the content at the position of the user's hand without transforming the information space. If no geometric transformations (e.g., zooming/scaling, distorting) have been performed on the information space, and the information space employs pixels as its internal representation (e.g., an image), the off-screen system can determine that the selected off-screen content of interest is around 360 pixels horizontally to the right of the rightmost screen pixel and 540 pixels vertically down from the topmost screen pixel based on the display's −3.78 pixel per mm and 1920×1080 resolution (see FIG. 5A). Since the spatial interaction techniques that were used cause this section of the off-screen information space to be brought on-screen, the system can draw the cursor on-screen at this location within the information space.

To provide the user with more flexibility over the cursor's final position, the cursor's location can be changed based on the horizontal and vertical distance between the user's index finger and the centre of the user's palm. When the distance is zero, the cursor's position does not change. When the user moves their index finger higher than their palm and more to the left, the cursor will move up and move left respectively. With the Dynamic Peephole Inset spatial interaction technique, the cursor was constrained to always be within its viewport. When this technique is used and the distance between the user's index finger and palm centre is zero, the cursor is horizontally and vertically centered within its viewport.

### Improving Spatial Selection

Performing mid-air selections with conventional techniques can be slow, imprecise, end difficult due to the technique being performed in 3D space, especially when no tactile feedback is present. The user can wear a special glove to provide feedback (e.g., [10]), but walk-up-and-use can be used. The off-screen system may also include a dynamically sized area cursor within the interaction space to help people perform spatial selections. If the distance from an object to the cursor is under a distance threshold, then the object is highlighted and is able to be interacted with. If more than one object is under this distance threshold, the closest object to the cursor is chosen.

To actually select the object with the tap gesture, the user may move their index finger along the Z-axis direction away from themselves, and surpass a minimum speed threshold as well as a minimum distance threshold. The same is required for deselection, but different threshold values may be used. For example, the speed threshold for selection may be about 2 cm per second and the speed threshold for deselection may be about 5 cm per second. Different thresholds may be used to avoid the system deselecting an object when the user is just trying to move it around. For example, when users move around a window/element/object after selecting it, users tend to move their hands in the Z direction which can trigger a deselection by accident. A solution to this issue is to make it “harder” to deselect. Since the object moves with the users hand after the object has been selected (in this example embodiment, as not all objects move when selected), it is easier to deselect it even more when “force/speed” is required. Selecting an object is harder since the user has to keep the cursor/their finger over the object while moving in the Z direction.

Some users have difficulty performing this selection technique since users tend to not move their finger parallel to the floor when performing a tap or pointing gesture, even when they know that the gesture requires movement along the Z-axis. Rather, the end of a user's finger tends to move along the Y and Z axes (e.g., down and in), and sometimes along the X-axis as well. Therefore, users may think they are surpassing the minimum speed threshold, but in actuality, they are not moving fast enough along the Z-axis. To help users properly perform this technique and select an object, the Z-axis velocity of the finger performing the mid-air tap gesture can be visualized. To accomplish this, the thickness of a highlighted shape that is used to inform the user when the cursor is hovering over an object can be changed (see FIG. 8B). A higher Z-axis velocity causes the highlighting thickness to increase. This provides feedback to allow users to see if they are performing the gesture correctly (i.e., moving fast enough along the Z-axis and moving along the correct axis that is required to perform the gesture) or if the user's finger movements are not being properly recognized by the motion sensing technology when the users are doing a mid-air tap selection gesture.

When performing the mid-air tap gesture, the tendency of the user's finger to move in multiple axes may also cause the cursor to move outside of the object's interaction space before the tapping gesture is detected. This can make it difficult to actually select an object, especially if it is small. The spatial interaction design of the off-screen system takes this into account and reduces the vertical and horizontal movement of the cursor based on the speed of the user's hand movement and index finger movement along the Z-axis. It effectively “locks” the pointer in place by employing an easily modifiable reduction function. This is accomplished by finding the difference between the tracked entity's (i.e., the user's finger or hand) current and previous locations (temporally distant), and multiplying it by a reduction function. Finally, adding this value to the entity's previous location may provide the entity's current “locked” position. The reduction function employed in the off-screen system divides a constant (set to one) by the square of the entity's velocity along the z-axis. Therefore, the cursor becomes more horizontally and vertically “locked” as the user moves faster along the Z-axis.

If the information space contains many objects, it can be quite easy to mistakenly select an object when the user puts their hand in the spatial interaction space. To mitigate this, the user's hands can be stabilized which can be monitored by analyzing the user's hand's spatial and temporal properties. If the user's hand has just entered the interaction space, the user must reduce the speed of their hand's movement towards the screen (z-axis) or surpass a time threshold before the user can use their hand to select an object with the spatial tap gesture.

With displays, it is easy to tell when the user reaches the edge of the interaction space due to the cursor stopping at the edge of the screen. With the off-screen interaction system, there is no direct visual feedback of the spatial sensor's interaction space. To provide feedback, the off-screen interaction system may display colored bands at the edges of the screen when the user is close to leaving the spatial interaction space. These bands can change to another color, like red, when the user's hand has left the interaction space.

With the off-screen exploration techniques described herein, when the user removes their hand from the spatial sensor's field of view this may reverse the geometric transformations that were applied to the information space in some embodiments. Therefore, when the user accidentally leaves the spatial interaction space, the user may have to restart the exploration technique. To mitigate this, in at least one embodiment, the user may be provided with a short time duration (e.g. a few seconds) to place their hand back within the interaction space to recapture the recent transformation state. If executed, the aforementioned bands may change colors (e.g. turn from red to green) to indicate a successful recapture, and then disappear after a few moments.

In at least one embodiment, the off-screen interaction system may determine the speed of the user's hand when it left the interaction space. If this speed is above a threshold, then the applied geometric transformations may be immediately reversed.

### Augmenting Dynamic Peephole Inset

In at least one embodiment, the off-screen interaction system may employ an augmented Dynamic Peephole inset spatial interaction technique by allowing each user's hand to be used to control their own respective viewports. This enables the user to explore the off-screen information space from different sides simultaneously when the user moves both of their hands simultaneously. The viewports can also be pinned to the display by performing a forward moving pinch gesture, as if the user is placing a thumb tack. Pinning a viewport removes the requirement of keeping the user's hand in the off-screen area; thus freeing up the user's hand to perform another task or for resting. Once pinned, a thumb tack is displayed near its top, and mouse or touch-based interaction techniques can be used to scale the viewport for closer inspection of the contents. To unpin the viewport, the user can perform a backwards moving pinch gesture (opposite of original gesture), or select the thumb tack with the mouse or directly with their finger touching the thumbtack on the display. When using the Dynamic Peephole Inset spatial interaction technique, the overview+detail visualization may be augmented with another viewfinder that represents the contents shown inside the exploration technique's viewport. This allows the user to better understand the relative location of the off-screen content within the viewport with respect to the entire information space. This is beneficial since the Dynamic Peephole Inset technique may not provide too much contextual visual information of the surrounding space due to the viewport only showing a small section of the off-screen information space.

### Desktop Example Embodiment

The prototype off-screen desktop augments the standard computer desktop with the ability to have application windows located off-screen. The off-screen space may be used for many functions such as, but not limited to, storing content such as when a user is working on a project and requires multiple windows open simultaneously. A lot of the time, all of these windows cannot fit on-screen without occluding one another. This can cause frustration and increase mental effort when the user is required to switch between many windows multiple times, since the user must search for the correct window from many candidates. The taskbar mitigates this, but it can still be frustrating when these windows are from the same application and look similar. To help with this issue, the user can store windows off-screen and use their spatial and proprioceptive memory to help them remember the stored location. If the user physically places an item on the right side of the display, the aforementioned cognitive processes helps the user remember on which side of the display they stored the content. Therefore, instead of using the task switcher keys (Alt+Tab) the user can use a spatial gesture to directly grab an off-screen window and bring it on-screen. A spatial push gesture may then be used to move the window back to its off-screen location. Also, by using a background image that is full of unique features, the memorability of where users have placed windows is likely enhanced.

It is also possible for the off-screen space to be used for hosting newly downloaded content. For example, a user may have their news or Twitter feed located off-screen and be able to view it only when needed. Having it located off-screen reduces potential distraction and cognitive load with respect to the user. New emails may arrive off-screen as well, and have an on-screen notification visualization to indicate its presence. The user may then use different swipe gestures to ignore or open that particular email.

The off-screen space may also be divided into sections for different purposes. These off-screen 2D areas may be called portals and they can be used to perform operations on content that is placed within them. For example, throwing a file into a specific portal may delete the file and throwing it into another portal may automatically send the file to another person or group by email. The 2D areas may be colored differently along with borders and text to indicate to the user their size, position, and what command is invoked on content that is placed within.

### Spatial Interactive Map Example Embodiment

In another embodiment, a map based spatial interaction system is provided. Map-based interfaces typically employ semantic zooming where the amount of displayed information increases as the zoom level increases. For example, street names and the location of stores are only displayed after surpassing a certain zoom threshold. When route planning, this information can be very useful for the user. If the route is too long to display on the screen, the user can zoom out to show the entire route, but loses the aforementioned information. At least some of the off-screen exploration techniques described in accordance with the teachings herein may be utilized to fix this problem by bringing the entire route on-screen. Other techniques described herein may also be used to view the off-screen section of the route and quickly snap back to the original on-screen section.

In an alternative embodiment, Instead of having the entire information space at the same zoom level, the on-screen section may be at a higher zoom and detail level than the off-screen sections. This may create a modified overview+detail interface where the on-screen section provides the detail and the off-screen sections provide context. Therefore, context may be provided on demand and does not take up screen space when not needed.

### Off-Screen Toolbars Example Embodiment

In the WIMP paradigm, part of the screen space is usually taken up by toolbars, ribbons and other control widgets (these are all collectively referred to as widgets). When not in use, these widgets can waste space, cause cognitive overload or be distracting to the user. To mitigate this, the off-screen space may be harnessed to contain these widgets when not in use. In at least one embodiment, in accordance with the teachings herein, the user may then use one of the off-screen spatial exploration techniques to bring this content on-screen. An off-screen interaction system may also make use of a window blind gesture metaphor to display a notification panel or taskbar that is originally located above the display. The user may perform a “pull down the blind” series of movements to invoke this operation. Another benefit is the implicit transience of the widgets being located on-screen. For example, the user can gesture to bring a toolbar on-screen, make a selection, and then move their hand back to the keyboard to continue working, which causes the toolbar to automatically move back off-screen. The system can either move the toolbar when the selection is made or when the user moves their hand out of the spatial interaction space. If the implicit transience of off-screen widgets is not appropriate for a specific task, the system may also be configured to support only moving the toolbar back off-screen when a specific gesture is performed.

### System-Wide & Application Specific Commands Example Embodiment

In another embodiment, the off-screen interaction system may be modified for document scrolling and volume control to invoke system-wide and application specific commands. These commands can be invoked with the use of fine grained gestures for tasks that require focus, or the use of coarse grained gestures when more “casual” interactions are needed [12]. Casual interactions are beneficial as they reduce the amount of focus that is required to perform them. This allows the user to perform a secondary task (e.g., ignore an email that appeared off-screen) while minimizing the performance loss incurred on the primary task. This example embodiment of the off-screen interaction system employs a simple spatial interaction technique to enable the user to read a document while panning its contents, or to change the operating system's volume. Volume and scrolling amounts are determined based on the vertical position of the user's hand with respect to the display. Document scrolling and muting/unmuting the volume may be performed by the user by using gestures such as vertical swipe gestures, for example.

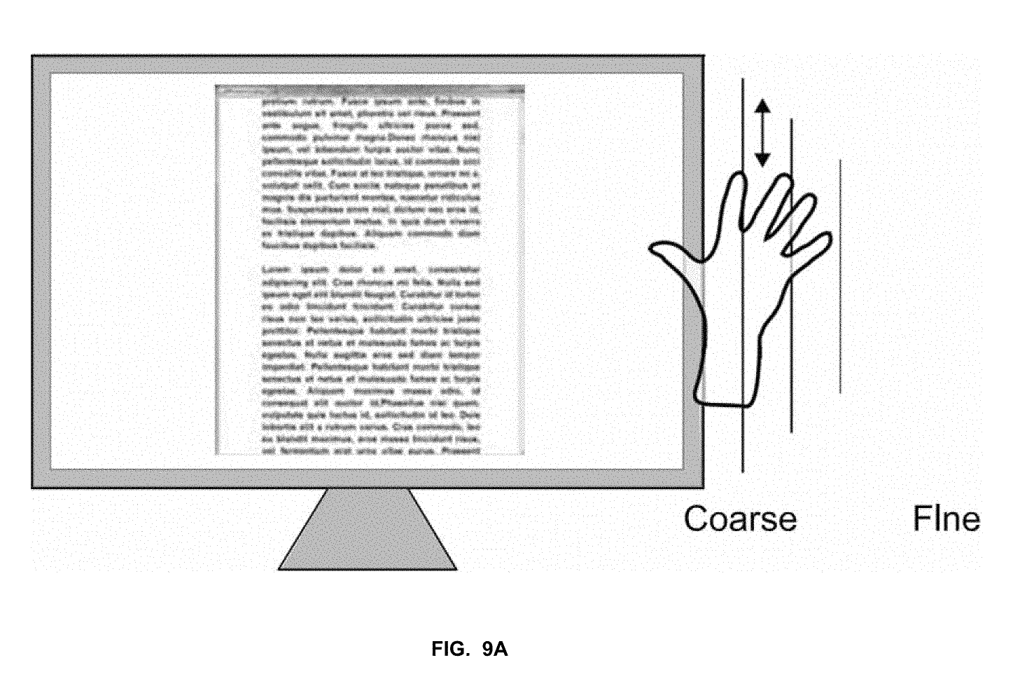

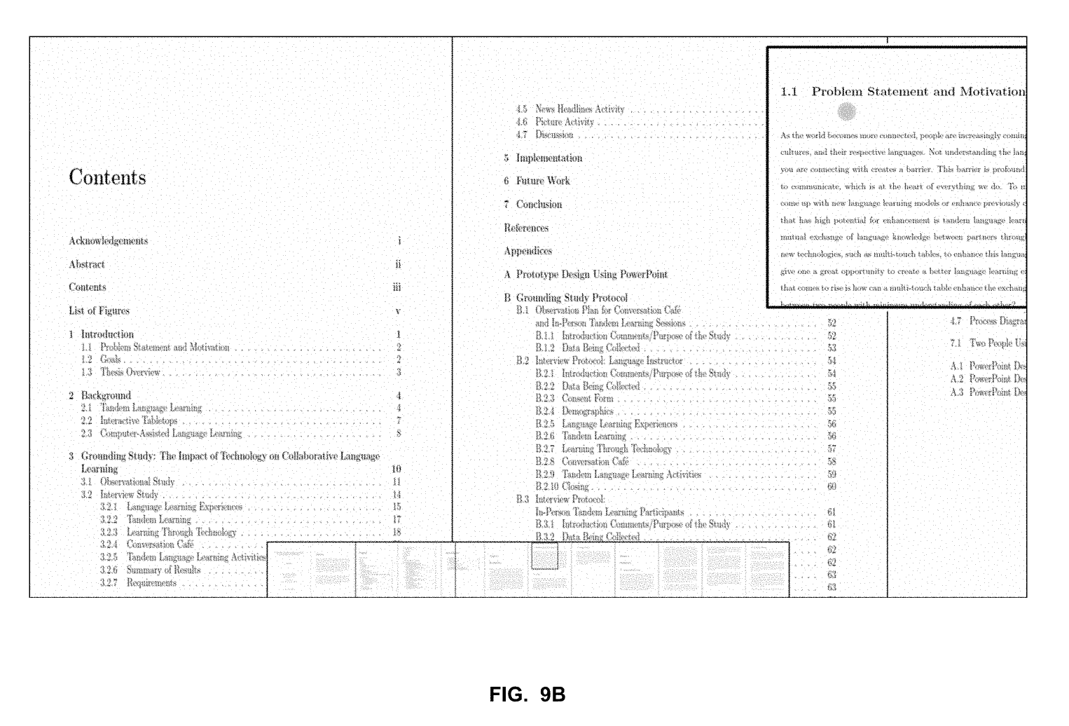

For example, the off-screen interaction system may support two different mappings when determining the volume or scrolling amounts based on the vertical position of the user's hand with respect to the display. In the first mapping method, the length of the document or total volume is normalized to the vertical height of the off-screen interaction space beside the display. For document scrolling, this allows the user to pan the document half way through by placing their hand at a vertical height that is defined by the vertical centre of the display. The second mapping method depends on the vertical position of the user's hand when it enters the off-screen interaction space and its subsequent vertical velocity (e.g. direction and speed) within that space. When the user moves their hand at a faster speed, the interaction's gain will increase. As seen in FIG. 9A, this mapping may make use of the user's hand's horizontal position with respect to the display to increase or decrease the scrollbar's scale precision (i.e. changing the gain of the interaction). For scrolling scenarios, this allows for a transition from coarse to fine grain scrolling. In an alternative embodiment, the gain of the interaction may be changed based on the content that is currently within the display viewport [8]. For example, a document may scroll faster when empty pages appear on screen and slow down when more important or informationally dense pages move into the display viewport.

These different mappings and gain control techniques can be employed in other scenarios that can make use of sliders and scrollbar widgets. For example, the user may change the volume of the system by vertically moving their hand beside the display, or seek a video the same way. In some embodiments, different parallel layers (i.e. distances from the screen) may be used to interpret the same gesture differently depending on which layer the gesture was performed in.

In at least one embodiment of the off-screen interaction system, different off-screen interaction areas may be mapped to different application windows. For example, the interaction area on the right side of the display may be mapped to a drawing application, and the left side of the display may be mapped to another instance of the same application or an instance of a different application. The user may then use spatial gestures on the right side of the display to draw within its corresponding application window, and do the same or different action on the left side without requiring one to manually change which window is in focus. This also allows one to interact with multiple applications simultaneously. For example, a user may draw in an application window with their left hand while gaining inspiration from a list of photos in another window which is being scrolled with the right hand.

### Document Exploration Example Embodiment

When reading a document, there are many scenarios where one is required to flip to a different page for a short duration and then return to the original page. For example, if a user comes across a term that was explained on an earlier page, but forgets its definition, the user might flip back to the earlier page to try and find the sentence explaining the term. Another example is that due to the structure of documents, figures and tables might not be located on the same page as the text that explains them or refers to them. Therefore, when the user comes across the explanation of a figure, the user might flip to the page containing the figure to better understand it. Also, analyzing and comparing figures on different pages using conventional means can cause the user to flip back and forth between pages multiple times. Another scenario is when the user is exploring or searching a document's contents by making use of its table of contents or index. The user might flip back and forth between page candidates and the index or table of contents until the content being sought Is found or the user Is finished exploring.

To aid in document exploration and mitigate page flipping, at least one embodiment of an off-screen interaction system is provided for document exploration. By laying out the document horizontally, the system Is able to effectively make use of at least some of the off-screen exploration techniques described herein to allow one to view content that is located on different pages (see FIG. 9B). If an earlier explanation of a term requires revisiting a previous page or a referenced figure is located on another page, the user can use a spatial interaction technique described herein to bring that content on-screen by simply placing their hand in the space beside the display that corresponds to this previous page or the other page. When finished, the user can quickly revert back to their original reading location by removing their hand from the spatial interaction space. For comparing multiple figures that are located on pages that are far apart, multiple instantiations of the Dynamic Peephole inset or distortion techniques can be employed to bring them on-screen. The off-screen exploration techniques described in accordance with the teachings herein also allow the user to quickly explore a document (e.g., Point2Pan), or keep the table of contents or index on-screen while looking at page candidates.

### Experimental Results

One way to integrate spatial interaction on a desktop computer is to use spatial gestures to control the pointer. This causes challenges since standard desktop graphical user interfaces (GUI) are designed for precise input devices such as the mouse. A typical virtual object's small display and interaction spaces reflect this and can lead to problems selecting items as well as other fundamental tasks. To mitigate this problem, a designer can integrate concepts from techniques that facilitate target acquisition (e.g., Bubble Cursor—Grossman, T. and Balakrishnan, R. (2005), The Bubble Cursor: Enhancing target acquisition by dynamic resizing of the cursor's activation area, in Proceedings of the SIGCHI Conference on Human Factors in Computer Systems, CHI '05, pages 281-290, New York, N.Y., USA, ACM)) into the mid-air selection gesture. After doing so, it is beneficial to test the gesture with people who are not accustomed to using the gesture. To gather data for analysis, one can video record and/or observe people as they use the gesture in conjunction with a GUI, as well as administer post-questionnaires and interviews. Log data from the gesture's usage can also be gathered. The problem with this is that, other than the video and observational data, these techniques produce mostly textual data and do not harness the full power of the human visual system, which makes the analysis difficult.

To mitigate these problems and help designers build better spatial user interfaces, as well as help to study the off-screen spatial interaction techniques, an application, which may be web-based, that visualizes logged spatial interaction data in accordance with the teachings herein may be used to analyze the study results. By first uploading a log file and an associated video screen capture of the display, an investigator can employ its features to analyze the 3D interactions and their effects on the GUI. This is not meant to replace any other method, but to fit within the investigative process to gain further insight into the related phenomena.

The visualization application was implemented using JavaScript, HTML, and the D3 visualization toolkit (Bostock, M., Ogievetsky. V., and Heer, J. (2011), D3 data-driven documents, IEEE Transactions on Visualization and Computer Graphics, 17(12):2301-2309). The D3 toolkit is a JavaScript library for manipulating documents based on data and builds on many concepts from the Protovis project (Bostock, M. and Heer. J. (2009), Protovis: A graphical toolkit for visualization, IEEE Transactions on Visualization and Computer Graphics, 15(6):1121-1128). The visualization application supports the spatial interaction data types provided by the Leap Motion controller used in the example experimental setup (described earlier) and assumes that the controller's interaction space is in front and centered with the display. A modified version of the application was created to handle interaction spaces at the sides of the display 16. This was done to visualize data gathered from the study of the off-screen interaction system in order to gain further insight into participant usage patterns. FIG. 10A shows an example embodiment of the visualization application and how SpatialVis (defined below) can be used for visualizing logged spatial interaction data.

The analysis application may be used to automatically log all associated spatial interaction data as a user interacts with the spatial interface. A video of this interface may also be recorded, using screen capture software, with a video length equal to the period of time that the user spent interacting with the interface. This allows log data to be mapped to the user interface events that occur in the video. When complete, the video and log files can be uploaded to a web analysis application, which may then display the video on one side of the interface with a heatmap and in some embodiments a path visualization may be overlaid on top of it. The analysis application (i.e. SpatalVi) may also include a timeline situated adjacent to the video, graphs of the interaction data adjacent another location of the video, and possibly a global heatmap as well as various controls (see FIG. 10A). When the video is played, the overlaid visualizations display spatial interaction data that is temporally related to the video's current frame.

Going back to the spatial target acquisition example discussed previously, an analyst can use the analysis application in conjunction with observational notes or a video recording of a user performing the gestures. For example, this may allow the analyst to view what data the motion sensing hardware is producing and if that matches up with the gesture that the user is trying to perform. If this analysis was done with logged data that was not visualized, the analyst may have to look through hundreds or thousands of lines of text which is very tedious.

Referring now to FIG. 10B, shown therein is an example of how a SpatialVi can be used in analysis to (a) visualize a portion of the spatial interaction data; (b) perform brushing to show data only associated for 8 to 12 seconds into the video; (c) save the visualization state; (d) add annotations to the spatial interaction data; (e) generate a heatmap of data associated with 8 to 12 seconds into the video and (f) generate a video timeline of the spatial interaction data.

The video timeline may be created by dividing the video into ten equally sized sections and using images from the beginning of each video segment to represent each section (see F in FIG. 10B). When the analyst hovers over one of the sections, its border changes colour (see purple box at the top of FIG. 10A) and they are then able to select the section to seek the video at the start of the section. If a section is selected, then the heatmap may be updated to show data only from this section's time range. If the video is then played, it may stop playing at the end of the selected section unless a widget on the left side of the interface is toggled. The timeline also contains a slider widget for seeking, while hovering over its handle will cause the play, pause and restart video controls to appear beside it.

The graphs below the video show spatial interaction information over the length of the video. The sizes of these graphs match the width of the timeline to allow the analyst to match the current time of the video (i.e. the slider's handle and the vertical line above) with the graph data, as well as to provide awareness of the video's current time value. The graphs may also be enabled with brushing and linking techniques (Keim, D. A. (2002), Information visualization and visual data mining, IEEE Transactions on Visualization and Computer Graphics, 8(1):1-8). Therefore, if the analyst discovers a time range with an interesting data pattern, the visual complexity of the interface can be reduced to allow the analyst to concentrate on this subset of data. This may be accomplished by selecting the data or time range of interest, which may then cause the rest of the data to be filtered out (see B in FIG. 10B). This brushing may then be reflected in the other graph, as well as in the heatmap and path visualization that are overlaid on top of the video. The video may also be seeked to the beginning of the time range associated with the brushed data and if played, may stop at the end of this range. If the analyst is interested in analyzing other spatial interaction data types, they can change the data visualized in each graph from a range of options Including pointables (tools and fingers), hands, all gestures, as well as each individual gesture type.

Different visualization techniques may be used to visualize each spatial interaction's location with respect to the analyst interface contained in the recorded video. This may be accomplished by overlaying them on top of the video using an orthographic projection mapping. A static heatmap may be used to visualize the frequency of gestures that were performed at different locations. Data is selected to be visualized in the heatmap if its associated frame is within a non-sliding window. When the analyst first loads the required data into the application, the window is the size of the entire video; therefore all of the gesture data is initially visualized. If the video is played or seeked, then the window's starting frame is set to the seeked location or the beginning of the video segment being played. The window's ending frame is then calculated by adding a user-changeable value, contained in a widget, to the starting frame. However, if the timeline sections or graphs are used to seek the video instead of the time slider, then the window's ending frame may be set to either the timeline section's last frame or the last frame associated with the selected graph data. The interface may also contains some other widgets that allow the analyst to set the window's ending frame to always be the last frame in the video, as well as to animate the heatmap over time using the data contained in its window.

The path of each pointable (i.e. finger or tool) may also be visualized using a semi-transparent path. For example, the pointable's Z-depth may be encoded using colour with either a monochromatic or dichromatic divergent colour scheme. In the example of FIGS. 10A-10B, the path contains green semi-transparent circles to visualize the location of each pointable when it was first detected by the spatial interaction sensor. To visualize a pointer's spatial location in the current frame, a red semi-transparent triangle may be attached to the end of the path. A white semi-transparent circle may also be affixed to the path for visualizing the spatial location of different gestures, such as swipe, screen tap and key tap. Other colors may be used for these geometric shapes in other embodiments. For example, the white circles in FIG. 10A show the location of discrete screen tap gestures. The visualization is dynamic since it displays data from a temporal sliding window that starts in the past and ends at the video's current frame. As the video plays, new data is visualized when it enters the sliding window and old data that is no longer inside the sliding window is removed. This aids the analysis process since interaction data may quickly disappear if only the current frame's data was visualized. The path visualization's sliding window may be automatically set to a low value, but the analyst has the ability to change it, such as when the analyst wants to visualize entire paths of all pointers.

In addition to the aforementioned visualizations, the analysis application allows the analyst to create their own visual markings by providing video annotation abilities (see D in FIG. 10B), which can then be used to label the location of interesting events, for example.

Since context is important for analysis, in at least one embodiment, a global context view of the gesture data may be included using a miniaturized image of the video that is overlaid with a heatmap that visualizes gesture data from the entire video. To further facilitate the analysis process, different visualization states may also be saved and loaded (see box C in FIG. 10B). The video frame with the overlaid visualizations and analyst annotations that are associated with a saved visualization state can then be downloaded as an image for sharing and offline analysis. The interface of the analysis application may also contain widgets on the left side to allow the analyst to show or hide one or more of the heatmap, path visualization, user annotations or the video itself. Opacity levels associated with the video and each component of the path visualization can be modified as well. The interface may also contain widgets to allow the video's playback speed and the colour of the annotation brush to be changed.

### Experimental Study

To evaluate the off-screen spatial interaction exploration techniques, a study was conducted to compare three of the spatial interaction techniques and standard mouse interaction when used to search for off-screen objects. A common interface was employed that typically deals with off-screen content: a map. Map-based interfaces are a classic example of where the information space can be and generally is larger than the size of the display. Other than changing the zoom level, panning with the mouse is the standard method of interacting with off-screen content in popular map applications (e.g., Google Maps, MapQuest, OpenStreetMap, and HERE). Panning with the mouse is used to bring this content on-screen for viewing and to enable the use of the pointer for further interaction.

A 2×2×4 factor within-subjects study design was used which included two tasks, two radial distance ranges, and four interaction techniques. In a real-world off-screen system, a user will already know an object's relative location if it was manually placed off-screen. Contrastingly, when the user's memory fades or when faced with an unfamiliar information space, the user will have to explore the off-screen area to find the content of interest. Therefore, the study was designed to determine how the different techniques performed when the user had to search for an object in the off-screen information space when its relative location was known and not known. The study was also designed to determine how the distance of the off-screen object with respect to the screen affected the performance of the techniques in each scenario. The techniques that were compared were panning with the mouse, Dynamic Distortion, Dynamic Peephole Inset with direct 1:1 mapping, and Direct Spatial Panning. The two study tasks were search and select-only, which involved selecting the correct off-screen object out of many choices (see below for more details). Each off-screen object was a certain distance from the centre of the information space, which gives rise to the two radial distance ranges of close and far (see below for more details).

Since only one section of the off-screen information space can be brought on-screen when using the mouse, the Dynamic Distortion and Dynamic Peephole Inset spatial interaction techniques were modified for the study in that only one side of the information space was allowed to be distorted at a time when using Dynamic Distortion, and the Dynamic Peephole inset technique only supported one viewport. Also, only the left and right side of the display supported spatial interaction in the study.

### Experimental Setup

The study setup included a desktop computer, a monitor, a keyboard, a mouse, and two Leap Motion controllers on a desk. The Leap Motion controllers were placed on the left and right sides of the display to enable spatial interaction in those areas as shown in FIG. 2A. The display was a Dell S2340T 58 cm (23 inch) multi-touch monitor with 1920×1080 high definition (HD) resolution (−3.78 pixels per mm) at 60 Hz and supported 10 simultaneous touch points. The computer was a Lenovo ThinkStation E31 with a 3.30 GHz Intel Core 15-3550 CPU, 6.00 GB of RAM, and a NVIDIA Quadro 2000 graphics card. The installed operating system was the 64-bit Professional version of Microsoft Windows. A Logitech Unifying receiver was used in conjunction with a Logitech wireless keyboard version K520 and a Logitech wireless mouse version M310. Both Leap Motion controllers were consumer versions (not the initially released developer versions) with firmware v1.7.0 and used v2.2.3 tracking software. To run both Leap Motion controllers on the same computer, the virtualization software package called VMware Player version 6.0.1 build-1379776 was used to run a Linux Mint 17 64-bit virtual machine. As shown in FIG. 2A, each Leap Motion controller had a horizontal distance of 35 cm and a depth distance of 7.5 cm from their respective centres to the centre of the display. The vertical distance from the desk to the bottom of the screen was 15 cm.

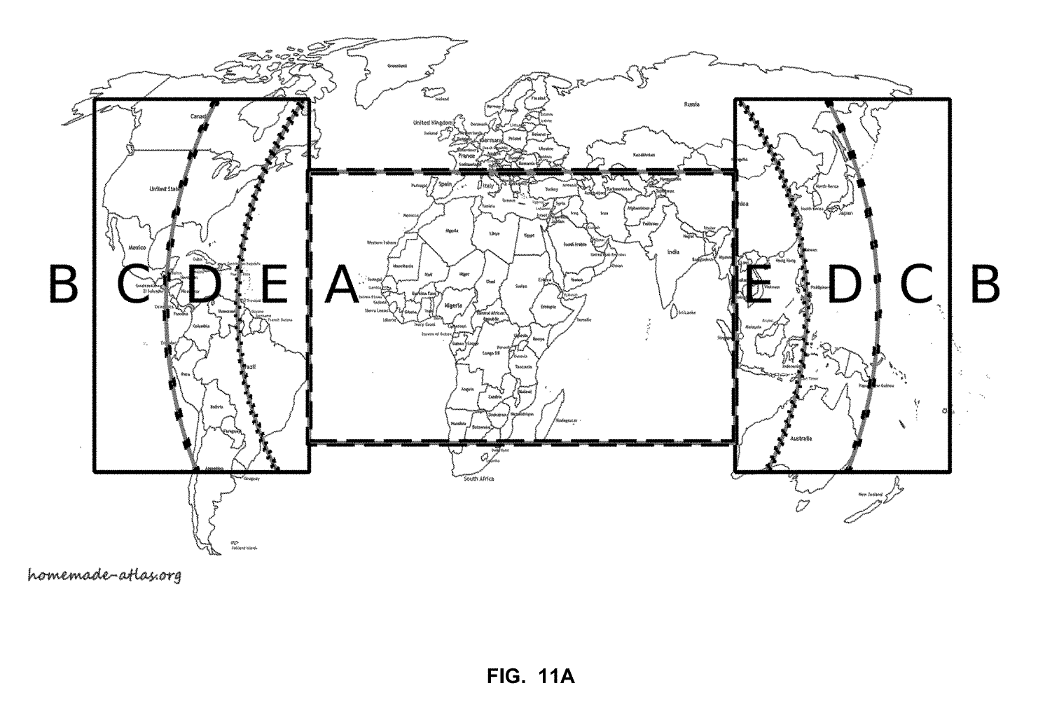

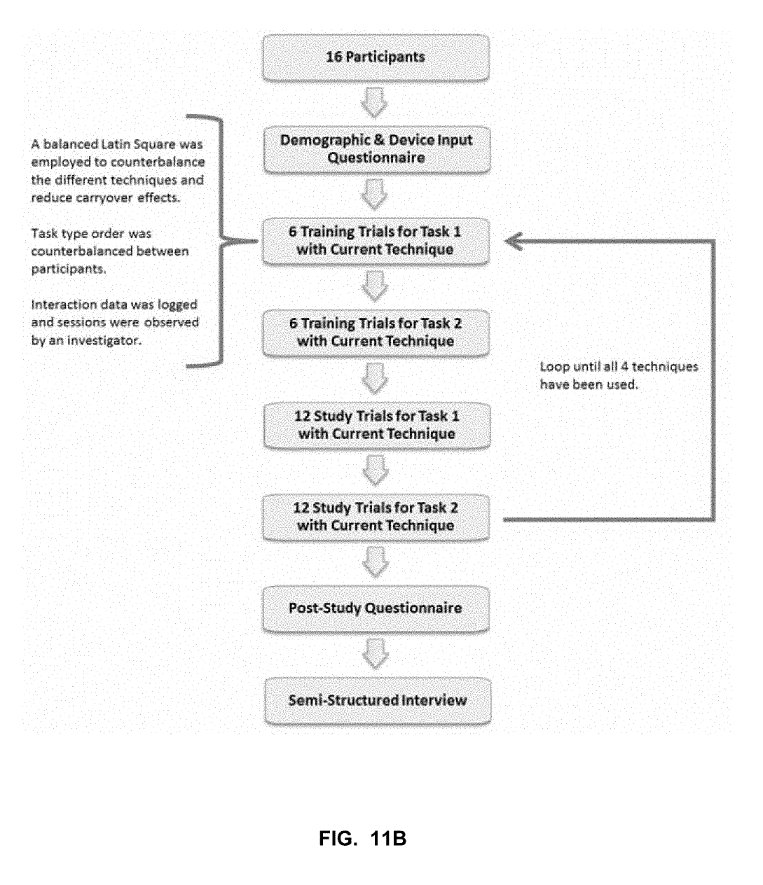

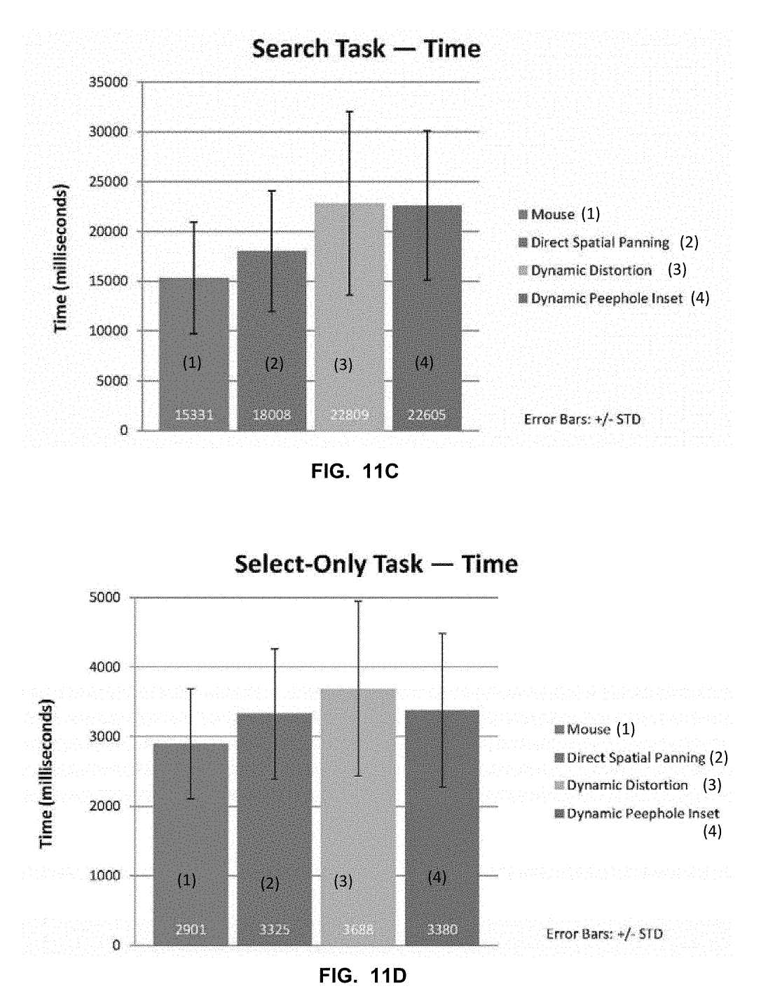

The off-screen desktop system was used to create the map interface that was used in the study. Although, this system supports zooming, this functionality was disabled for the study. A grayscale map of the Earth (cylindrical map projection) with country boundaries and names was used to define the landscape of the information space (see FIG. 11A). This map had a width of 4,500 pixels and a height of 2,234 pixels, while the display screen size was 1,920×1,080 pixels, and the initial display image (the box labelled “A” in FIG. 11A) was centered within the information space and was the area of the map that the study participants saw at the beginning of each test trial. The rectangles labelled “B” represent the areas where off-screen objects may appear. The regions labelled “C” defined the far radial distance range. The single target in each trial never appeared between the regions labelled “C” and “E”. The regions labelled “E” defined the close radial distance range. The region labelled “D” was used for testing purposes to separate the “near region” labelled “E” from the far region labelled “C”. In actual use, there is be no need for a separation of the regions labelled “C”, “D”, and “E”, as the entire off screen space is typically used, within the bounds of the motion sensor unit.

A map of the Earth was chosen since most people are familiar with it, which enables people to determine their general location in the information space by just analyzing what continents and countries are visible on-screen. The map originally had different colors for each country, but was made into a grayscale image to reduce the possibility of distraction; thus allowing the study participants to focus more on analyzing the off-screen targets.

The study involved two tasks, named search and select-only, where participants had to select the correct off-screen object out of 31 possibilities (i.e. one target and 30 distractors). In both tasks, each trial started with participants being presented with a copy of the target (reference) in a white square near the centre of the map. The target reference persisted for the entire duration of each trial at the same location in the information space to allow participants to refer to it when their memory faded. In the search task, participants had to search for the target and select it. In the select-only task, the location of the target was visualized with a diverging dichromatic arrow using blue at the tail and red at its head. The tail was always located at the centre of the screen with its head very close to the target. However, with the Dynamic Peephole Inset technique, two arrows were used since the map was never transformed to bring off-screen content on-screen when employing this technique. Therefore, the interface included the second arrow visualization Inside the off-screen viewport. These tasks were chosen to separate the direct to target (Fitts' law) type task from an exploration task which may require more extensive use of off-screen interaction techniques, therefore, generating more data for analysis.

To indicate when the participant can select an object, each object was highlighted when the cursor was within its interaction space. The highlighting employed a grey circle with a thin black border to create a luminance contrast break with surrounding colors [16]. Each object's interaction space was 80 pixels wide and 80 pixels tall. Since people are much more precise and faster when moving a cursor on a 2D surface (i.e. the mouse) when compared to a 3D space with no tactile feedback (i.e. spatial gestures), an area cursor was integrated into the spatial techniques. This effectively doubled each object's interaction space to 160 pixels wide and 160 pixels tall. For all techniques, participants performed a selection by hovering the cursor over the object and pressing the spacebar on the keyboard. This was designed in this fashion since a very mature and extensively used input device (i.e. the mouse) was being compared with a new input means (i.e. spatial interaction for off-screen information). In addition, a keyboard was used for selection since selection techniques were not being evaluated, but rather techniques for exploring the off-screen space and bringing off-screen content on-screen were being evaluated. The mouse technique employed the standard operating system cursor, and the spatial interaction techniques used a circular cursor that was purple. The standard operating system cursor was disabled in the spatial interaction trials.

For each trial, 31 distinct off-screen objects (one target and 30 distractors) were created and randomly placed off-screen. The objects included a triangle, a diamond, a circle, and a square that were grouped closely together in a random fashion. For each object, each of the shapes were randomly given one of four luminance controlled (75%) colors. No two shapes within an object contained the same colour. These colors were 90 degrees from each other on a circular HSL colour wheel. The colors were equiluminous to reduce preattentive processing effects to prevent shapes with certain colors from “popping out” [16]. Their RGB values were RGB (253, 160, 160), RGB (118, 230, 6), RGB (6, 219, 219), and RGB (205, 154, 252). To reduce contrast effects, each shape had a thin black border which created a luminance contrast break with surrounding colors [16].

For each object, each of its shapes had a random position and Z-depth ordering, but was never fully occluded. All of the shapes for an object fit within an area that was 80 pixels tall and 80 pixels wide, with a minimum distance of 20 pixels from each other's centroid. The borders of all shapes were two pixels thick. All squares, diamonds and circles were 40 pixels wide and 40 pixels tall (not including borders). All triangles were 40 pixels wide and 20 pixels tall (not including borders). Each of the objects had a minimum distance of 240 pixels from each other's centroid.

At the start of each trial, each object, except for the target, was randomly placed in off-screen areas depicted by the rectangles labelled “B” in FIG. 11A. Each of these areas did not encompass the full off-screen area in their respective space due to the sensing limitations of the Leap Motion controller. From pilot testing, it was concluded that the controllers did not detect spatial interactions reliably enough at the edges of the information space. Detection was possible, but required either lots of experience with the system and/or multiple attempts. Therefore, the edges of the information space were excluded for object placement by determining, with pilot testing, the size of the off-screen areas that provided adequate detection reliability. Each of the off-screen areas depicted by the rectangles labelled “B” in FIG. 11A had a width of 968 pixels (322 pixels from an edge) and a height of 1,484 pixels (288 pixels from the top edge and 462 pixels from the bottom edge). Although, the top and bottom edges had different heights, these dimensions maximized the amount of off-screen space where objects may be placed and reliably interacted with.

At the start of each trial, the single target was randomly placed within a subsection of the off-screen areas depending on the trial's associated radial distance range from the centre of the map. The rectangles labelled “C” and “E” in FIG. 11A depict the far and close distance ranges respectively. The minimum distance of the far range and the maximum distance of the close range were calculated based on dividing the width of one side's off-screen area (i.e. the rectangle labelled “B”) by three. Adding this value to the screen's width, which was first divided by two, gave the maximum radius distance for the close range. To get the minimum radius distance for the far range, this value was added twice instead of only once. The participants were not told about the regions for object placement. They were only told that the location of each off-screen object was randomly chosen at the start of each trial. A buffer region between the two distance ranges was employed to make sure that there was a minimum adequate difference in distance between any object in the close distance range and any object in the far distance range. This reduced the chance of two off-screen objects being right beside each other, yet residing in two different distance ranges.

The participants were 16 undergraduate and graduate students from the University of Ontario, Institute of Technology. Nine students were male and seven were female with ages ranging from 18 to 27 (M=21, SD=2.7). All of them were right handed and received $20 for participating in the study. Through self-reporting, all participants were screened to make sure they had normal or corrected-to-normal vision, full use of their arms and hands, and were not color blind. Three of them were familiar with the idea of interacting with off-screen content and two were familiar with the idea of off-screen pointing. In terms of input device usage, 81% of participants used a computer mouse daily and 81% had never used a Leap Motion controller before. Table 1 provides information for input device usage for the participants, which includes data on the computer mouse and different motion sensing systems.

TABLE 1
Input device usage data for all participants

| | | Used | Use a | | | |
|---|---|---|---|---|---|---|
| | Never | once | few | | | |
| | used | or | times | Use | Use | Use |
| | before | twice | a year | monthly | weekly | daily |
| Computer mouse | 0 | 0 | 0 | 1 | 2 | 13 |
| Leap Motion | 13 | 3 | 0 | 0 | 0 | 0 |
| controller | | | | | | |
| Microsoft Kinect | 9 | 5 | 1 | 1 | 0 | 0 |
| PlayStation Move, | 9 | 4 | 1 | 1 | 0 | 1 |
| Camera, or Eye | | | | | | |
| Motion capture | 12 | 3 | 1 | 0 | 0 | 0 |
| system (e.g., | | | | | | |
| Vicon, Natural | | | | | | |
| Point) | | | | | | |

At the start of the study, the participant filled out a questionnaire to gather demographic and device usage data. When finished, the investigator then explained and demonstrated the Leap Motion controller, the system setup, the size of the spatial interaction spaces, and the different interaction techniques employed in the study. Time was also spent to explain the most optimal hand orientations that increased the likelihood of the Leap Motion controller recognizing the spatial gestures. When ready, the participant sat in a chair that did not support reclining nor rotating, and was positioned at a close, but comfortable distance from the desk. The participant then practiced each of the different interaction techniques until they understood how to use them. For each interaction technique (4), the participant performed a training round of six trials with each study task (2), then performed a study round of twelve trials with each study task (2). A radial distance range was randomly chosen for each trial, but balanced to make sure that each round of trials contained the same number of close and far ranges. This resulted in 48 training trials and 96 study trials for each participant, and 1,536 total study trials for all participants.

Each study session lasted 60 to 80 minutes, and ended with a post-questionnaire and a semi-structured post-interview (see FIG. 11B). A balanced Latin Square was employed to counterbalance the different techniques and to reduce carryover effects. Task type order was counterbalanced between participants. Task completion time and accuracy were used as dependent variables, and user interaction data was logged. Participants were told to be as fast and accurate as possible when performing the different tasks. There was no time limit for each study trial, and participants could rest at any time as long as it was between trials. To gather additional data, a research investigator observed each study session.

Before the start of a round of trials, the name of the interaction technique, the phase (demo, practice, or study), and the task type was shown on a black screen. The participant then had to push the “w” and “\” keys at the same time to proceed. Before the start of each trial, a start button appeared on-screen and the map was centered to have equal off-screen space on the left and right side, as well as equal space above and below the display. To start the trial, the “w” and “\” keys had to be pressed at the same time. The start button then disappeared, and the reference target was displayed in a white square. The participant then performed the required task with the specified interaction technique. Participants only received feedback as to whether they selected the correct off-screen object during training rounds.

With spatial interaction, having one's hand inside the motion sensor's field of view at the start of a study trial can bias the results. Likewise, holding a mouse in one's hand can have the same effect. To prevent priming of interactions in the pilot test, the participants were originally requested to place both of their hands on the keyboard before the start of each trial. Unfortunately, participants forgot this request due to the repetitive nature and length of the study. Pushing the aforementioned two keys at the same time required participants to centre their hands on the keyboard at the start of each trial, which enforced the priming prevention method.

For the study, a number of hypotheses were proposed stemming from the inventors' experience in designing and using the different off-screen interaction techniques, as well as their knowledge in relation to human-computer interaction.

The mouse input device is widely used and very familiar to most people in technologically advanced societies. The same holds true for its associated panning technique especially in the context of map exploration. Most people do not have experience using spatial interaction to interact with desktop computers, let alone map applications. Also, the mouse is an indirect pointing device with an interaction gain. This means that it requires less physical movement for navigating an information space when compared to the spatial interaction techniques. Therefore, due to this as well as the average person's extensive past experience with the mouse and its panning technique, participants will have the fastest task completion times for both tasks when using this off-screen exploration technique (Hypothesis H1).

Each of the off-screen spatial exploration techniques in the study were designed to support the comparison of off-screen content with on-screen content. Direct Spatial Panning allows a user to quickly switch between viewing off-screen content and the original on-screen content by placing and removing the user's hand from the spatial interaction space. Dynamic Distortion transforms the information space to be able to bring off-screen content on-screen without removing the original on-screen content, and Dynamic Peephole Inset creates a small viewport on-screen that displays off-screen content. By keeping the reference object on-screen, it was believed that participants will be more likely to visually compare objects than to rely on their memory of the reference object, which can be prone to errors. Therefore, due to the Dynamic Distortion and Dynamic Peephole Inset methods being able to retain the reference object on-screen at all times, it was hypothesized that these two techniques will have a higher accuracy level than the other techniques for the search task (Hypothesis H2). Furthermore, it was believed that the Dynamic Peephole Inset method will have a higher accuracy level than Dynamic Distortion for the search task (Hypothesis H3) since the Dynamic Distortion technique distorts the original on-screen content, thus making it harder to compare objects with the reference object.

### Study Results

Study results from the formal evaluation include task completion time, accuracy, logged interactions, and questionnaire and interview data.

### Time & Accuracy

As previously mentioned, time (milliseconds) and accuracy were the dependent variables in the evaluation. The findings are discussed in relation to time and accuracy using a statistical significance level of α=0.05. Since the evaluation uses a repeated measures study design, the likelihood of incorrectly rejecting a true null hypothesis (Type 1 error) is increased. Therefore, where appropriate, the Bonferroni correction method was used to counteract the problem of multiple comparisons.

### Time

Three different tests of normality were performed to determine what type of statistical test should be used to analyze the time data. These included the Shapiro-Wilk tests, as well as calculating the skewness and kurtosis values. All factor combinations had p-values in the Shapiro-Wilk tests that were above 0.05, and skewness and kurtosis values within the acceptable range of −1.96 to +1.96. This meant that the data was approximately normally distributed and a parametric statistical test can be employed for analysis. Therefore, a 3-way repeated measures ANOVA with factors technique (4 levels), distance (2 levels), and task (2 levels) was used. The Mauchly's Test of Sphericity was performed and showed that the assumption of sphericity was not violated—technique: χ²(5)=3.732, p=0.590, technique*task: χ²(5)=3.692, p=0.595, technique distance: X²(5)=8.841, p=0.116, technique task*distance: X²(5)=7.442, p=0.191.

Analysis showed that there was a significant main effect for technique and task, and an interaction effect of technique*task (see Table 2). Post-hoc pairwise comparisons with Bonferroni correction showed that the mouse technique was significantly faster than the Direct Spatial Panning, Dynamic Distortion, and Dynamic Peephole Inset (see Table 3). Also, Direct Spatial Panning was significantly faster than Dynamic Distortion, and Dynamic Peephole Inset from the test results. See Table 4 for mean task completion time and confidence interval data for each technique. Table 5 shows the mean task completion time and confidence interval data for each radial distance range.

A post-hoc pairwise comparison showed a significant difference (p<0.0001) between task types, with participants completing the select-only task significantly faster than the search task. Mean and confidence interval data for each task are shown in Table 6. As mentioned earlier, an interaction effect between technique and task was found. For comparing the different techniques in the search task, post-hoc paired sample t-tests with Bonferroni correction were conducted, which found that participants were significantly faster in the search task when using the mouse technique when compared to the Dynamic Distortion and Dynamic Peephole Inset techniques (see Table 7).

FIG. 11C shows participant mean task completion time In milliseconds for the search task with the different techniques. FIG. 11D shows participant mean task completion time in milliseconds for the select-only task with the different techniques. Error bars in FIGS. 11C and 11D show the standard deviation for the test results therein.

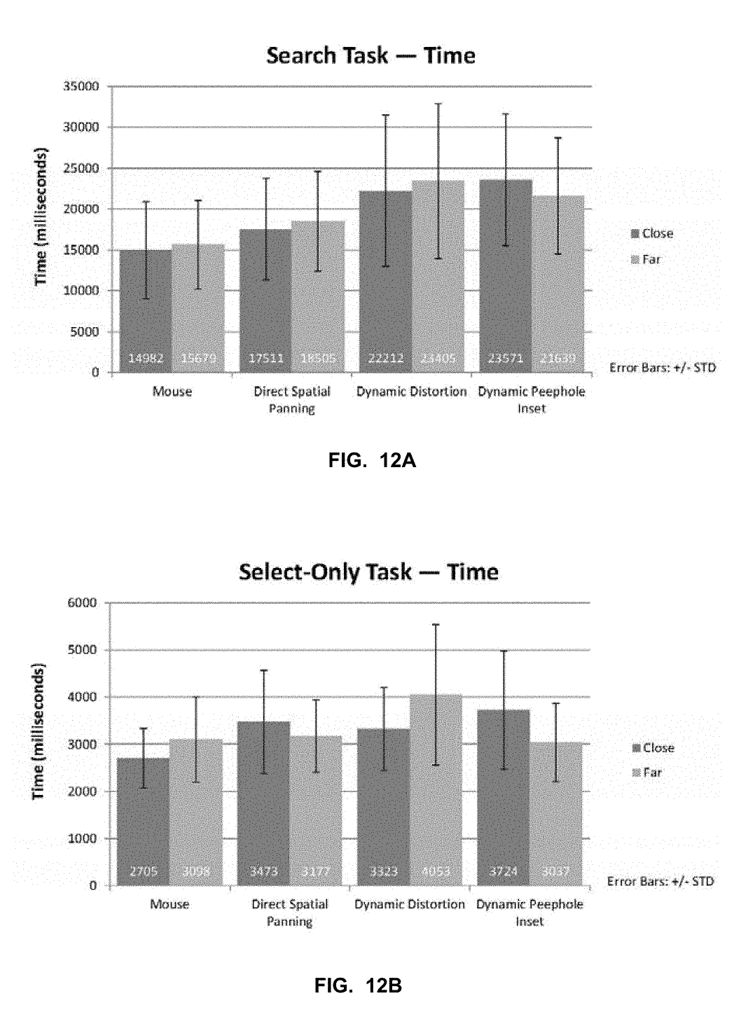

FIG. 12A shows the participant mean task completion time in milliseconds for the search task with the different interaction techniques in relation to the close and far radial distance ranges. FIG. 12B shows the participant mean task completion time in milliseconds for the select-only task with the different interaction techniques in relation to the close and far radial distance ranges. Error bars in both FIGS. 12A and 12B show the standard deviation of the experimental results.

TABLE 2
Results from a 3-way repeated measures ANOVA with factors
technique (4 levels), distance (2 levels), and task (2 levels).
Boldface results are statiscally significant.
3-Way Repeated Measures ANOVA for Time

| | | |
|---|---|---|
| Technique | F(3, 45) = 19.861 | p < .0001 |
| Task | F(1, 15) = 197.650 | p < .0001 |
| Distance | F(1, 15) = 0.080 | p = .781 |
| Technique * Task | F(3, 45) = 13.727 | p < .0001 |
| Techinique * Distance | F(3, 45) = 0.667 | p = .577 |
| Task * Distance | F(1, 15) = 0.056 | p = .816 |
| Technique * Task * Distance | F(3, 45) = 0.198 | p = .898 |

TABLE 3
Post-hoc pairwise comparisons of techniques with Bonferroni
correction. Boldface results are statistically significant. p-values greater
than 0.99 are due to Bonferroni correction.
Post-Hoc Pairwise Comparisons of Techniques for Time

| | | |
|---|---|---|
| Mouse | Direct Spatial Panning | p < .05 |
| | Dynamic Distortion | p < .0005 |
| | Dynamic Peephole Inset | p < .0005 |
| Direct Spatial Panning | Dynamic Distortion | p < .005 |
| | Dynamic Peephole Inset | p < .05 |
| Dynamic Distortion | Dynamic Peephole Inset | p > .99 |

TABLE 4
Mean task completion time and confidence interval data for each
technique. Time is in milliseconds.

| | | | | 95% Confidence | |
|---|---|---|---|---|---|
| | | | | Interval | |
| | | | Std. | Lower | Upper |
| Technique | Mean | Std. Dev. | Error | Bound | Bound |
| Mouse | 9116 | 7068 | 570 | 7902 | 10330 |
| Direct Spatial Panning | 10686 | 8313 | 680 | 9207 | 12126 |
| Dynamic Peephole Inset | 12993 | 10723 | 812 | 11199 | 14787 |
| Dynamic Distortion | 13248 | 10827 | 887 | 11357 | 15140 |

TABLE 5
Mean task completion time and confidence interval data for each
radial distance range. Time is in milliseconds.

| | | | | 95% Confidence | |
|---|---|---|---|---|---|
| | | | | Interval | |
| Radial | | | | Lower | Upper |
| Distance Range | Mean | Std. Dev. | Std. Error | Bound | Bound |
| Close | 11438 | 4570 | 724 | 9896 | 12980 |
| Far | 11574 | 4359 | 606 | 10155 | 12996 |

TABLE 6
Mean task completion time and confidence interval data for each
task. Time is in milliseconds.

| | | | | 95% Confidence Interval | |
|---|---|---|---|---|---|
| | | | | | Upper |
| Task | Mean | Std. Dev. | Std. Error | Lower Bound | Bound |
| Search | 19688 | 6471 | 1222 | 17083 | 22293 |
| Select-Only | 3324 | 936 | 186 | 2926 | 3721 |

TABLE 7
Post-hoc paired samples t-tests for technique time in search task
with Bonferroni correction. Boldface results are statistically significant. p-
values greater than 0.99 are due to Bonferroni correction.
t-tests for Technique Time in Search Task

| | | | |
|---|---|---|---|
| Mouse | Direct Spatial Panning | t(15) = −2.777 | p = .085 |
| | Dynamic Distortion | t(15) = −5.610 | p < .0001 |
| | Dynamic Peephole Inset | t(15) = −5.157 | p < .001 |
| Direct Spatial | Dynamic Distortion | t(15) = −4.112 | p < .01 |
| Panning | Dynamic Peephole Inset | t(15) = −3.395 | p < .05 |
| Dynamic | Dynamic Peephole Inset | t(15) = 0.167 | p > .99 |
| Distortion | | | |

Similarly, Direct Spatial Panning was found to be significantly faster than the Dynamic Distortion and Dynamic Peephole Inset techniques. For comparing the different techniques in the select-only task, post-hoc paired sample t-tests showed that participants were significantly faster in the select-only task when using the mouse technique compared to the Direct Spatial Panning and Dynamic Distortion techniques (see Table 12). Mean and confidence interval data for each technique in each task is shown in Table 8.

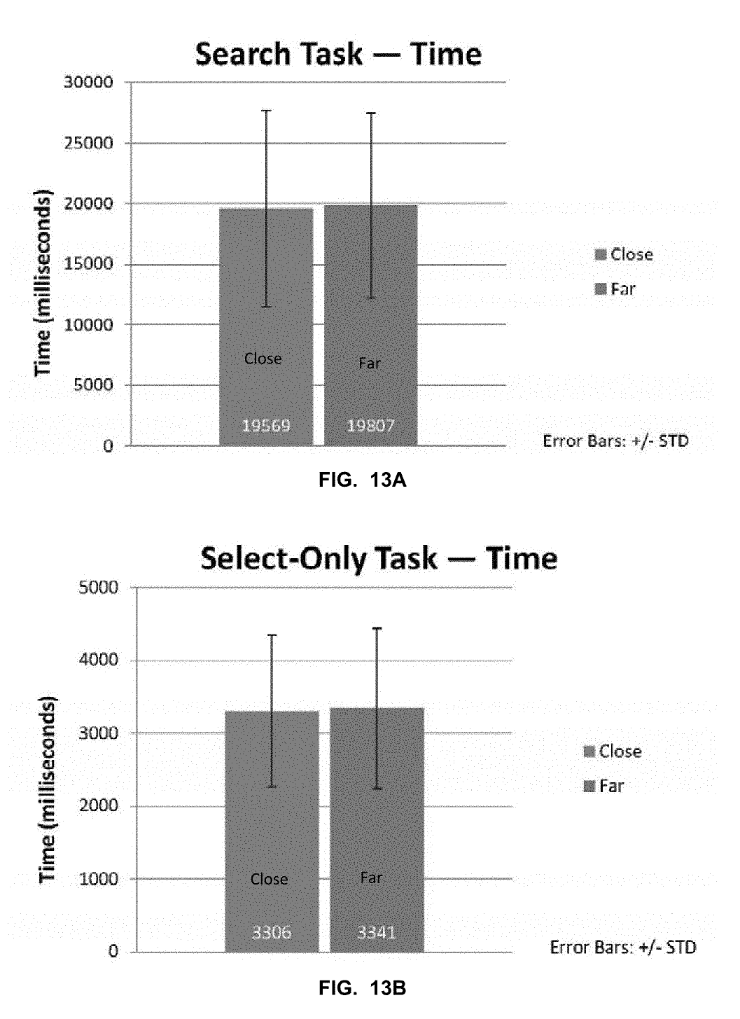

FIG. 13A shows participant mean task completion time in milliseconds for the search task in the close and far radial distance ranges. FIG. 13B shows participant mean task completion time in milliseconds for the select-only task in the close and far radial distance ranges. In both FIGS. 13A and 13B, the error bars show the standard deviation of the data therein.

TABLE 8
Mean task completion time and confidence interval data for
each technique in each task. Time is in milliseconds.

| | | | | | 95% Confidence | |
|---|---|---|---|---|---|---|
| | | | | | Interval | |
| | | | Std. | Std. | Lower | Upper |
| Technique | Task | Mean | Dev. | Error | Bound | Bound |
| Mouse | Search | 15331 | 4510 | 1127 | 12928 | 17731 |
| | Select- | 2901 | 709 | 177 | 2523 | 3279 |
| | Only | | | | | |
| Direct | Search | 18008 | 5220 | 1305 | 15227 | 20790 |
| Spatial | Select- | 3325 | 771 | 193 | 2914 | 3735 |
| Panning | Only | | | | | |
| Dynamic | Search | 22809 | 6785 | 1696 | 19193 | 26424 |
| Distortion | Select- | 3688 | 1103 | 276 | 3100 | 4276 |
| | Only | | | | | |
| Dynamic | Search | 22005 | 6285 | 1571 | 19256 | 29594 |
| Peephole | Select- | 3380 | 1017 | 254 | 2839 | 3922 |
| Inset | Only | | | | | |

TABLE 9
Mean task completion time and confidence interval data for each
technique in each radial distance range. Time is in milliseconds.

| | | | | | 95% Confidence | |
|---|---|---|---|---|---|---|
| | | | | | Interval | |
| | | | Std. | Std. | Lower | Upper |
| Technique | Distance | Mean | Dev. | Error | Bound | Bound |
| Mouse | Close | 8844 | 3298 | 736 | 7274 | 10413 |
| | Far | 9388 | 3157 | 708 | 7879 | 10898 |
| Direct | Close | 10492 | 3653 | 832 | 8719 | 12265 |
| Spatial | Far | 10340 | 3429 | 764 | 9212 | 12169 |
| Panning | | | | | | |
| Dynamic | Close | 12768 | 5061 | 1175 | 10203 | 15272 |
| Distortion | Far | 13729 | 5482 | 1262 | 11040 | 16118 |
| Dynamic | Close | 13647 | 4612 | 1043 | 11423 | 15971 |
| Peephole | Far | 12338 | 3966 | 948 | 10318 | 14358 |
| Inset | | | | | | |

TABLE 10
Mean task completion time and confidence interval data for each
task in each radial distance range. Time is in milliseconds.

| | | | | | 95% Confidence | |
|---|---|---|---|---|---|---|
| | | | | | Interval | |
| | | | Std. | Std. | Lower | Upper |
| Task | Distance | Mean | Dev. | Error | Bound | Bound |
| Search | Close | 19569 | 8102 | 1362 | 16666 | 22472 |
| | Far | 19807 | 7622 | 1241 | 17162 | 22452 |
| Select- | Close | 3306 | 1039 | 193 | 2896 | 3717 |
| Only | Far | 3341 | 1095 | 203 | 2908 | 3774 |

TABLE 11
Mean task completion time and confidence interval
data for each technique in each task in each radial
distance range. Time is in milliseconds.

| | | | | | | 95% Confidence | |
|---|---|---|---|---|---|---|---|
| | | | | | | Interval | |
| Tech- | | Dis- | | Std. | Std. | Lower | Upper |
| nique | Task | tance | Mean | Dev. | Error | Bound | Bound |
| Mouse | Search | Close | [symbol] | [symbol] | [symbol] | [symbol] | [symbol] |
| | | Far | [symbol] | [symbol] | [symbol] | [symbol] | [symbol] |
| | Select- | Close | 270 [symbol] | [symbol] | [symbol] | [symbol] | [symbol] |
| | Only | Far | [symbol] | [symbol] | [symbol] | [symbol] | [symbol] |
| Direct | Search | Close | [symbol] | [symbol] | [symbol] | [symbol] | [symbol] |
| Spatial | | Far | [symbol] | [symbol] | [symbol] | [symbol] | [symbol] |
| Panning | Select- | Close | [symbol] | [symbol] | [symbol] | [symbol] | [symbol] |
| | Only | Far | [symbol] | [symbol] | [symbol] | [symbol] | [symbol] |
| Dynamic | Search | Close | 2221 [symbol] | [symbol] | [symbol] | [symbol] | [symbol] |
| Distortion | | Far | [symbol] | [symbol] | [symbol] | [symbol] | [symbol] |
| | Select- | Close | [symbol] | [symbol] | [symbol] | [symbol] | [symbol] |
| | Only | Far | [symbol] | [symbol] | [symbol] | [symbol] | [symbol] |
| Dynamic | Search | Close | [symbol] | [symbol] | [symbol] | [symbol] | [symbol] |
| Peephole | | Far | [symbol] | [symbol] | [symbol] | [symbol] | [symbol] |
| Inset | Select- | Close | [symbol] | [symbol] | [symbol] | [symbol] | [symbol] |
| | Only | Far | [symbol] | [symbol] | [symbol] | [symbol] | [symbol] |

[symbol]

indicates data missing or illegible when filed

TABLE 12
Post-hoc paired samples t-tests for technique time in select-only
task with Bonferroni correction. Boldface results are statistically
significant. p-values greater than 0.99 are due to Bonferroni correction.
t-tests for Technique Time in Select-Only Task

| | | | |
|---|---|---|---|
| Mouse | Direct Spatial Panning | t(15) = −3.128 | p < .05 |
| | Dynamic Distortion | t(15) = −3.525 | p < .05 |
| | Dynamic Peephole Inset | t(15) = −2.384 | p = .18 |
| Direct Spatial | Dynamic Distortion | t(15) = −1.536 | p = .87 |
| Panning | Dynamic Peephole Inset | t(15) = −0.278 | p > .99 |
| Dynamic Distortion | Dynamic Peephole Inset | t(15) = 1.111 | p > .99 |

### Accuracy

In the select-only task where the location of the correct off-screen object was visualized to the participants, the accuracy of all participants in all trials with each technique and distance range was 100%. This pattern was not found in the accuracy data for the search task. Therefore, to determine what type of statistical test should be performed on the accuracy data gathered from the search task in each distance range, three different tests of normality were performed. These included Shapiro-Wilk tests, as well as calculating the skewness and kurtosis values, and determining if they lie within the acceptable range of −1.96 to +1.96. All three tests indicated that all of the different factor combinations were not well-modeled by the normal distribution and therefore the data could be not analyzed using parametric statistical methods. Thus, a non-parametric statistical test called the Friedman test was used to determine if there was a significant difference between groups of factors. For post-hoc analysis and for comparing individual factors, another non-parametric statistical test was used, called the Wilcoxon signed-rank test.

For the different techniques, the Friedman test showed no statistically significant difference between them in terms of accuracy levels for the search task, χ2(3)=2.392, p=0.495. No statistically significant difference between the two distance ranges for the search task was found as well, (Z=−1.434, p=0.151). The accuracy levels of the Individual techniques were analyzed to determine if they were affected by the two radial distance ranges (see Table 13). A Wilcoxon signed-rank test showed that participants were significantly more accurate with the mouse technique when targets were closer (M=0.9792, SD=0.083) to the centre of the screen than when they were farther away (M=0.9062, SD=0.16).

Statistical tests were also used to determine if techniques in the search task had significantly different accuracy levels depending on the distance of the off-screen objects from the centre of the screen. A Friedman test with the accuracy levels of the four different techniques in the close radial distance range were performed, which showed a significant difference among them, χ2(3)=10.500, p<0.05. However, further post-hoc analysis using Wiloxon signed-rank tests with Bonferroni correction showed no significant difference between any of the techniques (see Table 14). For targets farther away from the screen, a Friedman test of the four different techniques with the far radial distance range showed no significant difference among them in relation to accuracy levels, χ2(3)=1.087, p=0.780.

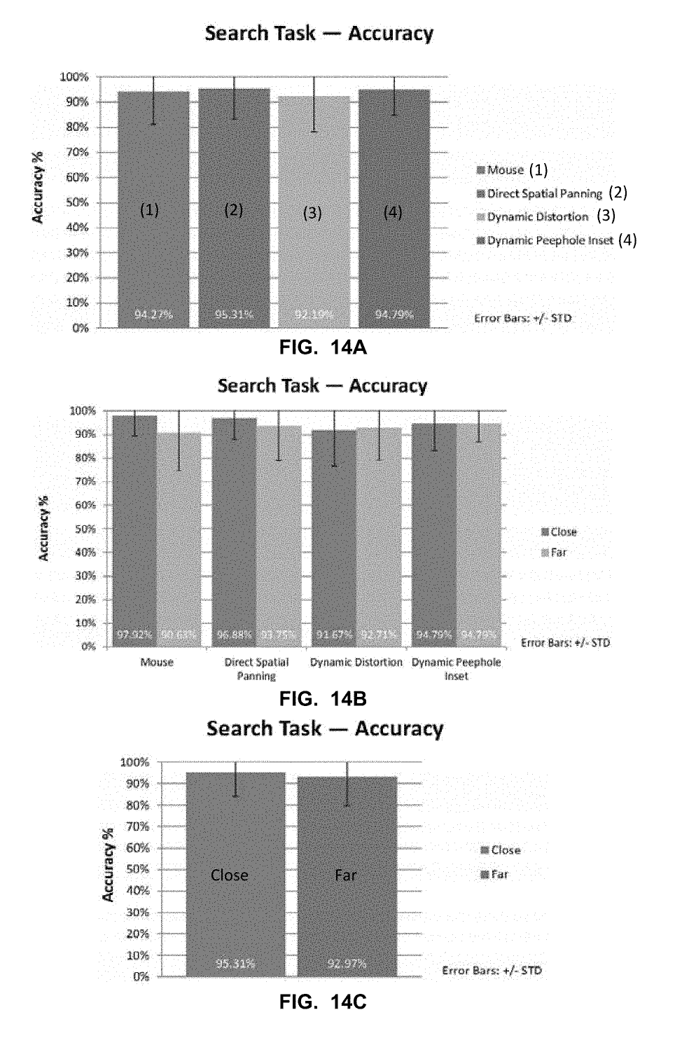

FIG. 14A shows experimental results of participant mean accuracy levels in percentages for the search task when using different interaction techniques. FIG. 14B shows experimental results of participant mean accuracy levels in percentages for the search task when using different interaction techniques in relation to the close and far radial distance ranges. FIG. 14C shows experimental results of participant mean accuracy levels in percentages for the search task in the close and far radial distance ranges. In FIGS. 14A-14C, the error bars show the standard deviation of the data therein.

TABLE 13
Wilcoxon signed-rank tests for accuracy of techniques between
radial distance ranges for the search task. Boldface results are
statistically significant.
Wilcoxon Tests for Accuracy of Techniques Between Distance Ranages

| | | | |
|---|---|---|---|
| Mouse - Close | Mouse - Far | Z = −2.070 | p < .05 |
| Direct Spatial | Direct Spatial | Z = −1.134 | p = .257 |
| Panning - Close | Panning - Far | | |
| Dynamic | Dynamic Distortion - Far | Z = −0.272 | p = .785 |
| Distortion - Close | | | |
| Dynamic Peephole | Dynamic Peephole | Z = −0.412 | p = .680 |
| Inset - Close | Inset - Far | | |

TABLE 14
Wilcoxon signed-rank tests with Bonferroni correction for
accuracy of techniques in the close radial distance range for the search
task. No statistically significant differences were found. p-values greater
than 0.99 are due to Bonferroni correction.
Wilcoxon Tests for Accuracy of Techniques in Close Distance Range

| | | | |
|---|---|---|---|
| Mouse | Direct Spatial Panning | Z = −1.000 | p > .99 |
| | Dynamic Distortion | Z = −2.121 | p = .204 |
| | Dynamic Peephole Inset | Z = −1.342 | p > .99 |
| Direct Spatial | Dynamic Distortion | Z = −1.890 | p = .364 |
| Panning | Dynamic Peephole Inset | Z = −1.000 | p > .99 |
| Dynamic Distortion | Dynamic Peephole Inset | Z = −1.732 | p = .498 |

### Qualitative Data

To gather additional data, participants filled out a post-study questionnaire and participated In a semi-structured post-study interview. The findings are discussed below.

### Interview

The semi-structured interview centered on study participants' experience in using the different techniques for the two different tasks. For all techniques, the study participants stated that their strategy for finding off-screen targets was to analyze the on-screen reference object, then explore the surrounding off-screen space. When the reference object was not always situated on-screen, some study participants only looked at it again to refresh their memory. Other participants always looked at the reference object before selecting an off-screen object to make sure that they matched. A number of study participants stated that they were easily able to memorize what the target looked like and therefore did not need to look at the reference object again after committing it to memory. Most of the study participants stated that they did not search a particular side of the display first on purpose. With relation to the spatial interaction techniques, the study participants liked how they could envision the physical location that their hand needed to be in to view content at a specific location in the information space.

Most study participants stated that they liked the mouse technique due to it being very familiar on account of them having lots of experience with this input device type. The study participants also found that the mouse supported the most fine-grained control out of all of the techniques. However, some study participants found the mouse to be slower than the spatial interaction techniques, and did not like how the reference object moved off-screen when exploring the information space. Study participants also did not like how the mouse technique required clutching. The Direct Spatial Panning was well liked since it felt like the mouse technique, and study participants said that the interaction was easy, fast, natural and fluid. Study participants also found this technique to require the least amount of effort to explore the off-screen space. As with the mouse technique, study participants did not like how the reference object did not remain on-screen.

For the search task, study participants liked how the reference object always stayed on-screen in the Dynamic Distortion technique, which helped comparing off-screen objects. The ability to reduce the space between objects and bring a large number of them on-screen simultaneously was liked and made analyzing objects faster for some. Although, some study participants found the technique to be difficult due to the continuous distortion effects. Some study participants also found the technique to be more challenging when used to explore and select objects that were in the off-screen corner spaces.

Some study participants found that the Dynamic Peephole inset technique was the easiest and fastest technique when used for the select-only task. These study participants stated that they were able to use the arrow visualization to judge the distance of the target from the screen's edge, and immediately “jump” to that location by positioning their hand in the respective physical space. Although, for the search task, participants did not like how their view of the off-screen space was limited and did not provide enough context due to the small size of the viewport. However, some study participants found that searching for targets was easier due to the viewport reducing the size of information space that needs to be analyzed at each moment in time; thus facilitating concentration. Participants also liked how the reference object always stayed on-screen and was never distorted.

### Questionnaire

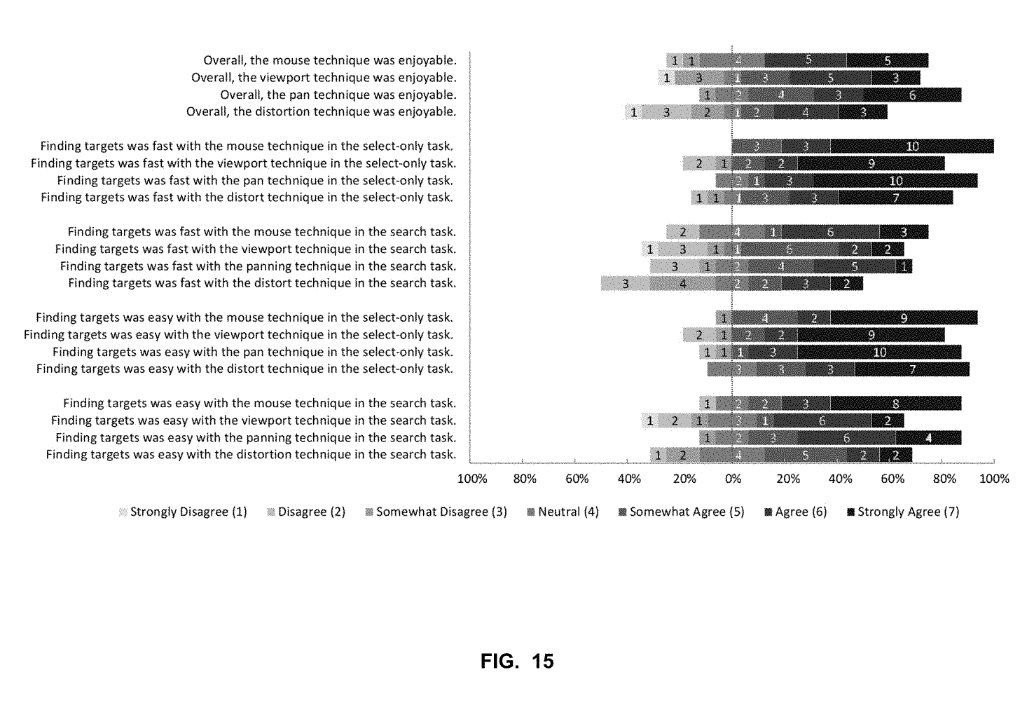

Using a 7-point Likert scale from Strongly Disagree to Strongly Agree, the questionnaire asked participants questions related to the usability of the different techniques. These included how “easy” and “fast” the different techniques were in each task for finding off-screen targets, and overall how “enjoyable” they were to use. It also asked participants to rank the different techniques in order of preference for finding targets, as well as overall preference. Table 15 and FIG. 15 show the actual questions from the questionnaire along with their mean and standard deviation, as well as overall percentages, respectively of the questionnaire answers. In FIG. 15, the study participants' answers to the 7-point Likert scale questions and the number within a bar represents the number of study participants who gave that response and its width represents the percentage of study participants. The questions refer to Dynamic Distortion as “distort”, Dynamic Peephole Inset as “viewport” and Direct Spatial Panning as “pan”. Table 16 and Table 17 show the technique ranking results.

TABLE 15
Post-study questionnaire data using a 7-point Likert scale. Responses
from Somewhat Agree to Strongly Agree are used to calculate the Total Agree
score. The same pattern is used to calculate the Total Disagree score. The
questions refer to Dynamic Distortion as “distort”, Dynamic Peephole Inset as
“viewport”, and Direct Spatial Panning as “pan”.

| | Total | Total | | |
|---|---|---|---|---|
| Questions | Agree | Disagree | Mean | STD |
| Overall, the mouse technique was enjoyable. | 10 | 2 | 5.38 | 1.69 |
| Overall, the viewport technique was enjoyable. | 11 | 4 | 5.00 | 1.75 |
| Overall, the pan technique was enjoyable. | 13 | 1 | 5.69 | 1.50 |
| Overall, the distortion technique was enjoyable. | 9 | 6 | 4.30 | 2.07 |
| Finding targets was fast with the mouse technique in the select-only task. | 16 | 0 | 6.44 | 0.81 |
| Finding targets was fast with the viewport technique in the select-only task. | 13 | 8 | 5.76 | 1.84 |
| Finding targets was fast with the pan technique in the select-only task. | 14 | 0 | 6.31 | 1.04 |
| Finding targets was fast with the distort technique in the select-only task. | 15 | 2 | 3.69 | 1.69 |
| Finding targets was fast with the mouse technique in the search task. | 10 | 2 | 3.13 | 1.63 |
| Finding targets was fast with the viewport technique in the search task. | 10 | 5 | 4.38 | 1.86 |
| Finding targets was fast with the pan technique in the search task. | 10 | 4 | 4.63 | 1.63 |
| Finding targets was fast with the distort technique in the search task. | 7 | 7 | 4.25 | 1.77 |
| Finding targets was easy with the mouse technique in the select-only task. | 15 | 1 | 6.15 | 1.20 |
| Finding targets was easy with the viewport technique in the select-only task. | 13 | 3 | 5.75 | 1.81 |
| Finding targets was easy with the pan technique in the select-only task. | 14 | 2 | 6.18 | 1.31 |
| Finding targets was easy with the distort technique in the select-only task. | 13 | 0 | 5.88 | 1.30 |
| Finding targets was easy with the mouse technique in the search task. | 13 | 1 | 5.88 | 1.30 |
| Finding targets was easy with the viewport technique in the search task. | 9 | 4 | 4.69 | 1.89 |
| Finding targets was easy with the pan technique in the search task. | 18 | 1 | 5.63 | 1.20 |
| Finding targets was easy with the distortion technique in the search task. | 9 | 3 | 4.69 | 1.40 |

TABLE 16
Participants ranking of the techniques in order of preference for
finding targets from 1 (least preferred) to 4 (most preferred).
Ranking of Techniques for Finding Targets

| Technique | Mean | STD | Rank - 4 | Rank - 3 | Rank - 2 | Rank - 1 |
|---|---|---|---|---|---|---|
| Mouse | 2.88 | 1.1 [symbol] | 7 | 2 | [symbol] | 2 |
| Direct | 2.81 | 0.7 [symbol] | 3 | 7 | 6 | 0 |
| Spatial | | | | | | |
| Panning | | | | | | |
| Dynamic | 2.2 [symbol] | 1.24 | 3 | 5 | 1 | 7 |
| Distortion | | | | | | |
| Dynamic | 2.0 [symbol] | 1.1 [symbol] | 3 | 2 | 4 | 7 |
| Peephole | | | | | | |
| Inset | | | | | | |

[symbol]

indicates data missing or illegible when filed

TABLE 17
Participants ranking of the techniques in overall preference
from 1 (least preferred) to 4 (most preferred).
Ranking of Techniques for Overall Preference

| Technique | Mean | STD | Rank - 4 | Rank - 3 | Rank - 2 | Rank - 1 |
|---|---|---|---|---|---|---|
| Direct | 2.81 | 0.91 | 4 | [symbol] | 5 | 1 |
| Spatial | | | | | | |
| Panning | | | | | | |
| Mouse | 3. [symbol] | 0.9 [symbol] | 4 | 4 | 7 | 1 |
| Dynamic | 2. [symbol] | 1. [symbol] | 5 | 3 | 1 | 7 |
| Peephole | | | | | | |
| Inset | | | | | | |
| Dynamic | 2.1 [symbol] | 1.20 | 3 | 3 | 3 | 7 |
| Distortion | | | | | | |

[symbol]

indicates data missing or illegible when filed

### Logged Interactions

To gain insight into how the off-screen exploration techniques were employed for searching and moving around the information space, the study participants' movement and positional data in the off-screen space was visualized. To accomplish this, the SpatialVis system, explained previously, was used and an ad-hoc Java application was made to create heatmaps and path visualizations. Using these systems, aggregated data over all study participants, all techniques, and all trials, was viewed as well as data only for each technique, each study participant or each trial.

The off-screen interaction space (left or right side) that study participants first used when looking for targets in the search task, as well as how often they changed sides was also recorded. For all of the off-screen exploration techniques (36 study trials per study participant), the study participants searched the left side first on average 17 times and searched the right side first on average 18 times. For those same 36 study trials, study participants switched sides on average 23 times, which is an average of 0.65 times per trial. For Direct Spatial Panning (12 study trials), study participants searched the left side first on average 6.1 times and searched the right side first on average 5.9 times. For those same 12 study trials, study participants switched sides on average 8 times, which is an average of 0.67 times per trial. For Dynamic Distortion (12 study trials), study participants searched the left side first on average 5.7 times and searched the right side first on average 6.3 times. For those same 12 study trials, study participants switched sides on average 8.2 times, which is an average of 0.68 times per trial. For Dynamic Peephole Inset (12 study trials), study participants searched the left side first on average 5.4 times and searched the right side first on average 6.6 times. For those same 12 study trials, study participants switched sides on average 7.1 times, which is an average of 0.59 times per trial.

### Heatmaps

The heatmaps visualized the position of the study participants' palm centre with respect to the information space. This visualization was possible due to the off-screen exploration techniques employing a direct 1:1 mapping from the physical space around the screen to the actual information space. A colour scheme of blue to red to white with white areas containing the largest amount of positional data was used in the heatmaps.

### Path Visualizations

To help understand how study participants moved around the information space while using the off-screen exploration techniques, hand movement data was visualized using semi-transparent paths. As with the heatmaps, this was possible due to the off-screen exploration techniques employing a direct 1:1 mapping from the physical space around the screen to the actual information space. The colors orange, blue, and purple were used to visualize the Dynamic Distortion, Direct Spatial Panning, and Dynamic Peephole Inset techniques respectively.

### Discussion—Mouse

As expected, study participants had the fastest task completion times for both tasks when using the mouse. Statistical analysis showed that the mouse technique was overall significantly faster than all of the other techniques, was significantly faster than Dynamic Distortion and Dynamic Peephole Inset in the search task, and was significantly faster than Dynamic Distortion and Direct Spatial Panning in the select-only task. For each task type, the mouse received the highest mean scale rating with respect to its perceived speed and usability (“easiness”). This was due to the mouse and its associated panning technique being widely used by the study participants before the study. This was shown by the study participant demographic data where 81% of the study participants indicated that they used a computer mouse every day. Furthermore, most people are not used to spatially interacting with their computers. People have experience in performing coarse mid-air gestures (e.g., waving, pointing, etc.), but generally not for controlling anything that requires fine-grained control, such as a computer cursor. For the motion sensing devices listed, the study participant demographic data showed that 91% of study participants had only used devices that support spatial interactions a few times in their lives. For the Leap Motion controller, 81% of the study participants had never used one before the study and the rest only had a few experiences. Therefore, the study was comparing the performance of a technology (mouse) using expert users, against novice users of another technology (spatial interaction). It takes time to get used to the interactions involved in moving something precisely around in 2D by using a 3D space without force feedback. It is also believed that the mouse technique performed the best since it is an indirect pointing device with an interaction gain, and the distance from the keyboard (i.e., trial start position for hands) to the mouse was smaller than the distance to the spatial interaction space (i.e., beside the display). Study participants also experienced less fatigue when using the mouse since their hand and wrist could rest on the desk, and only needed to make small movements to explore the entire information space (gain of the indirect interaction) when compared to the spatial techniques.

Although, similar to what has happened with the mouse, as people gain more experience in using spatial interaction and as the motion sensing technology continues to advance, there may be an increase in people's overall spatial interaction performance and preference. In terms of the future for desktop computers, the mouse will most likely still be a main pointing device, but the inclusion of spatial interaction into systems as a complementary interaction modality may further help to decrease the barrier between human and machine. This is especially true for those with physical disabilities that cannot make use of the mouse. In other words, a spatial interaction technique does not need to perform better than the standard technique (i.e. mouse) for it to be useful and worthwhile. For example, people are notoriously slower and more error-prone when typing with touch-based virtual keyboards compared to physical keyboards, yet they are accepted and widely used every day.

### Discussion—Spatial Off-Screen Exploration Techniques

The performance results of the spatial off-screen exploration techniques are positive as they show that these techniques perform almost as well as the mouse with very little training. Direct Spatial Panning had the highest accuracy levels out of all of the techniques in the search task, and was the fastest spatial technique in both tasks. Statistical analysis found that it was overall significantly faster than the other two spatial techniques, as well as for the search task. The study participants also found the Direct Spatial Panning technique to be the most enjoyable, and ranked it as the most preferred technique overall. In terms of perceived usability (“easiness”) for finding targets, this technique received the highest mean scale rating when used for the select-only task, and the second highest for the search task. For perceived speed in relation to finding targets in both tasks, it also received the second highest mean scale rating. These results indicate that Direct Spatial Panning was the best spatial off-screen exploration technique for the study tasks. This is not surprising since the technique is very fluid. It is therefore the easiest spatial technique for novices to transition to from the standard off-screen interaction technique (i.e. mouse) in terms of the cognitive processes involved.

Dynamic Distortion and Dynamic Peephole inset were not found to be significantly faster or more accurate than any other technique. In both tasks, Dynamic Distortion had the slowest task completion times with Dynamic Peephole Inset being the second slowest technique by doing slightly better. Overall, participants enjoyed the Dynamic Distortion technique the least, ranked it last for overall preference and second last for preference in relation to finding targets. For the same qualitative metrics, Dynamic Peephole insets scores were second last out of the four techniques, except for participant preference in relation to finding targets where it was ranked last. Participants also perceived the Dynamic Distortion technique as being the slowest for finding targets in both tasks, with Dynamic Peephole inset coming in second last. For perceived usability (“easiness”) for finding targets, both techniques tied for last place in the search task, with Dynamic Distortion beating Dynamic Peephole Inset for third place in the select-only task. These results are heavily influenced by task appropriateness. It is believed that Dynamic Distortion and Dynamic Peephole Inset may be more beneficial in tasks that require glancing at off-screen content, such as looking ahead in a book, or bringing social media content (e.g., a Twitter feed) temporarily onscreen. These two spatial techniques may also be beneficial when the task requires viewing off-screen content and on-screen content simultaneously, such as during the comparison of highly complex information.

In the study sessions participants appeared to have trouble with the Dynamic Distortion technique which was due in part to the Leap Motion controller being less robust in terms of spatial recognition in the areas close to its cameras as well as vertically far away. This problem was mitigated by reducing the off-screen space where targets may potentially be placed as depicted by the rectangles labelled “B” in FIG. 11A. However, the problem still occurred if the study participant's hand orientation was not well recognized by the Leap Motion controller. In addition, the small stature and arm length of some of the study participants made it more difficult for them to optimally place their hands in the space above the display. Therefore, the Dynamic Distortion technique performed poorly but this was due to the technical difficulties just mentioned and not due to the technique itself. Another problem with the Leap Motion controller was that due to the biomechanical properties of the human arm, staying within the motion sensor's field of view is more difficult when making large vertical movements. People tend to pivot at the elbow which causes the hand to move along the Z and Y axes which increases the possibility of the hand moving outside of the spatial interaction space.

In terms of technique accuracy performance in the search task, no statistically significant difference was found. Although not statistically significant, the study participants were the least accurate with Dynamic Distortion in the search task. This is understandable since some study participants stated in the post-study interview that the distortion effects caused by this technique increased the difficulty of visually comparing objects. This was exacerbated when the reference object was distorted differently than other objects of interest. Also, the entire reference object or some of its important features were easy enough for a number of study participants to remember which reduced the need for it to remain on-screen. If the study participants did forget, they could just bring the reference object back on-screen to refresh their memory.

It is believed that the performance of the spatial techniques in the study was negatively affected by study participant fatigue, and how the techniques required one to make larger physical movements than the mouse (indirect pointing device with an interaction gain). Some study participants did experience fatigue due to the repetitive nature of the study, and the fact that the spatial techniques required one to make a large movement at the start of each trial. This large movement involved moving from the keyboard to the space beside the display. Fatigue was exacerbated since spatial techniques require the study participants to hold and move their hand in mid-air without any support.

### Discussion—Target Radial Distance Ranges: Close and Far

The radial distance ranges did not play a major factor in relation to accuracy in the search task, except when the mouse technique was used. The study participants were significantly more accurate with the mouse when targets were closer to the screen. A similar non significant pattern occurred when all techniques were aggregated in the search task, as well as when comparing the distances with respect to the Direct Spatial Panning technique. A possible explanation for the mouse being significantly more accurate with closer targets is that the study participants might have been more likely to bring the reference object back on-screen when less effort was required. Doing so would allow the study participants to double check if the object of interest was in fact the correct target. Surprisingly, the Dynamic Distortion technique was slightly less accurate when targets were closer to the screen. This may be due to the fact that some study participants tended to place their hand farther away from the display in the off-screen corner space at first when searching with this technique. This strategy allowed the study participants to gain a larger overview of the off-screen space. This may have resulted in the lower accuracy level since closer objects have a higher probability of becoming distorted when the study participant's hand is placed in the off-screen corner space, with this probability increasing as the distance between the hand and the display becomes larger.

In terms of task completion time, no significant difference was found between the two radial distance ranges for both task types. This is possibly due to the off-screen space not being large enough for differences in distance to significantly affect performance. The study participants were slightly faster in both tasks when targets were closer to the screen. This makes sense, especially when the location of the target is known, since a person has to travel a smaller distance in the information space to reach a closer target. Although, interestingly, the study participants were faster with the Direct Spatial Panning and Dynamic Peephole Inset techniques when targets were farther away from the screen in the select-only task. Some study participants stated in the post-study interview that they were able to use the arrow visualization to judge the distance of the target from the screen's edge, and immediately “jump” to that location. This might be due to the study participants overestimating the distance between the target and the side of the display.

In the search task, the study participants were faster with all of the techniques when targets were closer, except for when the Dynamic Peephole Inset was used. Based on the inventors' experience of personally using these techniques, as well as observing other people using these techniques, the discrepancy might be due to the fact that people tend to not place their hand very close to the display when first exploring the off-screen space. Doing so requires more mental effort since one must avoid hitting the actual side of the display. When coupled with the limited view and context of the off-screen space that is provided by the Dynamic Peephole Inset technique, closer targets might have had a higher probability of being missed by the study participants. To mitigate this, in some embodiments an overview and detail visualization with an additional viewfinder that represents the location of the off-screen content that is shown by the technique can be shown. People may then use this to determine the content's exact position in the information space and make sure that they explore the entire surrounding area.

### Discussion—Logged Interactions

With respect to using the spatial interaction techniques in the search task, the study participants were found to switch sides on average less than one time per trial. They also started searching the off-screen space pretty evenly with the study participants searching the right side first a tiny bit more than the left side, even though all of the study participants were right handed. This is surprising since it was thought that the study participants might start searching for targets, for the most part, by first using their dominant hand and the off-screen space closest to it, whether consciously or unconsciously. Due to the repetitive nature of the study and the fatigue that occurs when repetitively moving one's hand in mid-air, the resulting evenness is possibly due to the study participants attempting to distribute the physical effort between both arms.

When comparing the heatmaps and path visualizations for both tasks, it makes sense that the study participants traversed less of the off-screen interaction space in the select-only task. This was due to the fact that the arrow visually indicated the section of the off-screen space that contained the target, whereas the study participants had no help when exploring for targets in the search task. Therefore, the study participants were more likely to fully explore the off-screen space in the search task. The heatmaps and path visualizations of the different spatial techniques give an insight into how the different techniques work. The location and movement of participants' hands when using the Dynamic Peephole Inset and the Dynamic Distortion techniques show how one must position their hand in the actual physical off-screen space to view the virtual content that is mapped to that location. This is due to the Dynamic Peephole Inset's small viewport size, and how the Dynamic Distortion technique was configured to vertically distort the information space when one's hand is above or below the display, according to one example embodiment. With the Direct Spatial Panning technique, users can take advantage in embodiments in which the entire information space is translated to bring the off-screen content that is associated with the user's hand's physical location to the centre of the screen. This results in a large section of the information space being brought on-screen whenever the user moves their hand in the off-screen interaction space. Therefore, to see content that resides above the display, this technique may not require the user to physically place their hand in that exact location. Users may move their hand in the off-screen space until the content of interest appears at the edge of the on-screen space. Accordingly, in some embodiments, the user may move their hand around the screen more with the Dynamic Peephole Inset and Dynamic Distortion techniques than with the Direct Spatial Panning technique to explore the same amount of off-screen information. One can view this in the study by comparing the heatmap and path visualizations of the Direct Spatial Panning technique with the visualizations of the Dynamic Peephole Inset and Dynamic Distortion techniques. This comparison shows how less of the off-screen information space was physically traversed when the study participants used the Direct Spatial Panning technique for the example embodiments used in the study.

The spatial interaction techniques described in accordance with the teachings herein seem to complement touch interaction more than mouse/keyboard interaction since the movement from direct touch to spatial interaction is more fluid, as well as easier and quicker. Popular mobile devices support touch interaction, and moving within their around-device (or around display) space is quick and easy. Therefore, the spatial techniques described according to the teachings herein may be well suited for touch-enabled mobile devices.

In another example embodiment, at least some of the spatial interaction techniques described herein may be extended to employ the user's hand's 3D position in the space around the display to determine the X, Y and Z coordinates of off-screen content that is of interest. Furthermore, in another example embodiment, Dynamic Distortion may be implemented to allow the user to distort the Z-axis in addition to the X and Y axes, which may enable users to bring content with different Z-depth values on-screen simultaneously.

In another example embodiment, the user may be allowed to change the camera angle that is used to render off-screen content by rotating their hand in mid-air. This may be supported in the Dynamic Distortion and/or Dynamic Peephole inset spatial interaction techniques, and may allow the user to view on-screen content and content that was originally off-screen at different angles simultaneously.

It should be noted that with respect to the placement and position of off-screen content, the spatial interaction techniques described herein do not have to use any binning discretization techniques. Therefore, objects can be placed anywhere in the off-screen interaction space and overlap with one another. However, in alternative embodiments binning support may be added to affect the usability of the system. A wide range of different discretization techniques may be used and may have varying levels of effectiveness depending on the type of information or applications that are used with the off-screen information space.

In at least some alternative embodiments, the off-screen space may not be divided In a curvilinear fashion, but rather a rectilinear grid or grids that make use of other shape types (e.g., triangle, other polygons) may be used.

While the applicant's teachings described herein are in conjunction with various embodiments for illustrative purposes, it is not intended that the applicant's teachings be limited to such embodiments as these the embodiments described herein are intended to be examples. On the contrary, the applicant's teachings described and Illustrated herein encompass various alternatives, modifications, and equivalents, without departing from the embodiments described herein, the general scope of which is defined in the appended claims.

### REFERENCES

[1] Baudisch, P. and Rosenholtz, R. (2003). Halo: A technique for visualizing off-screen objects. In Proceedings of the SIGCHI Conference on Human Factors in Computing Systems, CHI '03, pg. 481-488, NY, NY, USA. ACM.
[2] Colgan, A. (2014). How does the Leap Motion controller work? http://blog. leapmotion.com/hardware-to-software-how-does-the-leap-motion-controller-work/. Accessed: 2015-06-13.
[3] Ens, B., Ahlström, D., Cockburn, A., and Irani, P. (2011). Characterizing user performance with assisted direct off-screen pointing. In Proceedings of the 13^{th} International Conference on Human Computer Interaction with Mobile Devices and Services. MobileHCl '11, pg 485-494, New York, N.Y., USA. ACM.
[4] Gustafson, S., Baudisch, P., Gutwin, C., and Irani, P. (2008). Wedge: Clutter-free visualization of off-screen locations. In Proceedings of the SIGCHI Conference on Human Factors in Computing Systems, CHI '08, pages 787-796, New York, N.Y., USA. ACM.
[5] Gustafson, S. G. and Irani, P. P. (2007). Comparing visualizations for tracking off-screen moving targets. In CHI '07 Extended Abstracts on Human Factors in Computing Systems, CHI EA '07, pages 2399-2404. New York, N.Y., USA. ACM.
[6] Hincapié-Ramos, J. D., Guo, X., Moghadasian, P., and Irani, P. (2014). Consumed endurance: A metric to quantify arm fatigue of mid-air interactions. In Proceedings of the SIGCHI Conference on Human Factors in Computing Systems, CHI '14, pages 1063-1072, New York, N.Y., USA. ACM.
[7] Hinckley, K., Pausch, R., Goble, J. C., and Kassell, N. F. (1994). A survey of design issues in spatial input. In Proceedings of the 7th Annual ACM Symposium on User Interface Software and Technology, UIST '94, pages 213-222, New York, N.Y., USA. ACM.
[8] Hwang, S., Gim, J., Yoo, J., and Bianchi, A. (2015). Contextual drag: Context based dynamic friction for dragging interaction. In CHI '15 Extended Abstracts on Human Factors in Computing Systems, CHI EA '15, pages 167-167, New York, N.Y., USA. ACM.
[9] Kaltenbrunner, M. (2009). reacTIVision and TUIO: A tangible tabletop toolkit. In Proceedings of the ACM International Conference on Interactive Tabletops and Surfaces, ITS '09, pages 9-16, New York, N.Y., USA. ACM.
[10] Koch, K., Walker, T., Ji, Y., Gravesmill, K., Kwok, J., and Garcia. M. (2015). Hands Omni haptic glove. http://news.rice.edu/2015/04/22/games-feel-the-glove-from-rice-engineers-2/. Accessed: 2015-06-27.
[11] Leap Motion (2015). https://www.leapmotion.com/. Accessed: 2015-06-13.
[12] Pohl, H. and Murray-Smith, R. (2013). Focused and casual interactions: Allowing users to vary their level of engagement. In Proceedings of the SIGCHI Conference on Human Factors in Computing Systems, CHI '13, pages 2223-2232, New York, N.Y., USA. ACM.
[13] Reas, C. and Fry. B. (2006). Processing: programming for the media arts. AI & SOCIETY, 20(4):526-538.
[14] Shneiderman, B. (1996). The eyes have it: A task by data type taxonomy for information visualizations. In Proceedings of the 1996 IEEE Symposium on Visual Languages, VL '96, pages 336-343, Washington, D.C., USA. IEEE Computer Society.
[15] Stuerzlinger, W. and Wingrave, C. A. (2011). The value of constraints for 3D user interfaces. In Brunnett, G., Coquillert, S., and Welch, G., editors, Virtual Realities, pages 203-223. Springer Vienna.
[16] Ware, C. (2004). Information Visualization: Perception For Design. Elsevier, 2^{nd} edition.
[17] Zellweger, P. T., Mackinlay, J. D., Good, L., Stefik, M., and Baudisch, P. (2003). City lights: Contextual views in minimal space. In CHI '03 Extended Abstracts on Human Factors in Computing Systems, CHI EA '03, pages 838-839, New York, N.Y., USA. ACM.

1. A system that provides spatial interaction with off-screen content, wherein the system comprises:
a display for displaying initial on-screen content;
a motion sensor unit for detecting gestures made by a user for selecting desired off-screen content and generating spatial interaction data; and
a processing unit coupled to the display and the motion sensor unit, the processing unit being configured to define an information space that comprises on-screen content and off-screen content that extends physically past one or more boundaries of the display and a spatial interaction mode, and upon receiving spatial interaction data from the motion sensor unit of a user gesture that corresponds to the spatial interaction mode, the processing unit is configured to apply a geometric transformation to the information space so that the on-screen content that is displayed by the display is modified to include the selected off-screen content.

2. The system of claim 1, wherein the processing unit is configured to inverse the applied geometric transformation after the motion sensor unit detects that the user's gesture is completed.

3. The system of claim 1, wherein the processing unit is configured not to inverse the applied geometric transformation after the motion sensor unit detects that the user's gesture is completed when the processing unit detects that the user has also locked the information space.

4. The system of claim 3, wherein the processing unit is configured to inverse the applied geometric transformation when the processing unit detects that the user unlocks the view.

5. The system of claim 1, wherein the physical space surrounding the display is divided into off-screen interaction volumes.

6. The system of claim 5, wherein the off-screen interaction volumes comprise at least one of an upper left corner volume, an above volume, an upper right corner volume, a right volume, a lower right corner volume, a below volume, a lower left corner volume, a left volume, an in front volume, and a behind volume.

7. The system of claim 1, wherein the spatial interaction modes comprise at least one of paper distortion, dynamic distortion, content-aware distortion, point2pan, spatial panning and dynamic peephole inset.

8. The system of claim 7, wherein in the paper distortion and dynamic distortion modes, the processing unit retains the initial on-screen content, compresses/warps and displays the initial on-screen content, and displays selected off-screen content by translating the off-screen content onto the display.

9. The system of claim 7, wherein in the paper distortion mode, when the processing unit detects that the user makes at least one contact with the display, the display records the at least one contact as tactile spatial interaction data which is used to determine a portion of the initial on-screen content that is compressed.

10. The system of claim 7, wherein in the dynamic distortion mode, the motion sensor unit is constantly monitoring movement in the user's gesture and the movement is used to dynamically change the amount of compression that is applied to the initial screen content.

11. The system of claim 7, wherein in the point2pan mode, the processing unit detects that the user gesture comprises the user pointing towards the desired off-screen content, and the processing unit translates the information space to display the desired off-screen content.

12. The system of claim 11, wherein the processing unit is configured to translate the information space so that the desired off-screen content is centered on the display.

13. The system of claim 7, wherein in the content-aware distortion mode, the processing unit applies a geometric transformation to regions of pixels of the initial on-screen content based on an information content in the regions of pixels.

14. The system of claim 7, wherein in the dynamic peephole inset mode, the processing unit uses the position of the user's hand in the off-screen information space to define content that is placed in an inset/viewport that is shown on the display.

15. The system of claim 14, wherein an overview and detail visualization with an additional viewfinder that represents a location of the selected off-screen content is shown.

16. A method of allowing a user to spatially interact with off-screen content of a device, wherein the method comprises:
defining an information space that comprises on-screen content and off-screen content that extends physically past one or more boundaries of the display and a spatial interaction mode;
displaying initial on-screen content on a display;
detecting a gesture made by a user for selecting desired off-screen content using a motion sensor unit and generating spatial interaction data;
upon receiving the spatial interaction data from the motion sensor unit of a user gesture that corresponds to the spatial interaction mode, applying a geometric transformation to the information space so that on-screen content that is displayed by the display is modified to include the selected off-screen content.

17. The method of claim 16, wherein the method comprises inversing the applied geometric transformation after the motion sensor unit detects that the user's gesture is completed.

18. The method of claim 16, wherein the method comprises not inversing the applied geometric transformation after the motion sensor unit detects that the user's gesture is completed when the processing unit detects that the user has also locked the information space.

19. The method of claim 18, wherein the method comprises inversing the applied geometric transformation when the processing unit detects that the user unlocks the view.

20. The method of claim 16, wherein the physical space surrounding the display is divided into off-screen interaction volumes.

21. The method of claim 20, wherein the off-screen interaction volumes comprise at least one of an upper left corner volume, an above volume, an upper right corner volume, a right volume, a lower right corner volume, a below volume, a lower left corner volume, a left volume, an in front volume, and a behind volume.

22. The method of claim 16, wherein the spatial interaction modes comprise at least one of paper distortion, dynamic distortion, content-aware distortion, point2pan, spatial panning and dynamic peephole inset.

23. The method of claim 22, wherein in the paper distortion and dynamic distortion modes, the method comprises retaining the initial on-screen content, compressing/warping and displaying the initial on-screen content and displaying selected off-screen content by translating the selected off-screen content onto the display.

24. The method of claim 22, wherein in the paper distortion mode, when the processing unit detects that the user makes at least one contact with the display, the method comprises recording the at least one contact as tactile spatial interaction data, and using the tactile spatial interaction data to determine a portion of the initial on-screen content that is compressed.

25. The method of claim 22, wherein in the dynamic distortion mode, the method comprises constantly monitoring movement in the user's gesture and using the movement to dynamically change the amount of compression that is applied to the initial screen content.

26. The method of claim 22, wherein in the point2pan mode, the processing unit detects that the user gesture comprises the user pointing towards the desired off-screen content, and the method comprises translating the information space to display the desired off-screen content.

27. The method of claim 26, wherein the method comprises translating the information space so that the desired off-screen content is centered on the display.

28. The method of claim 22, wherein in the content-aware distortion mode, the method comprises applying geometric transformation to regions of pixels of the initial on-screen content based on an information content of the regions of pixels.

29. The method of claim 22, wherein in the dynamic peephole inset mode, the processing unit uses the position of the user's hand in the off-screen information space to define content that is placed in an inset/viewport that is shown on the display.

30. The method of claim 29, wherein the method comprises showing an overview and detail visualization with an additional viewfinder that represents a location of the selected off-screen content.
